(19) United States
(12) Patent Application Publication
(10) Pub. No.: US 2023/0096560 A1
(43) Pub. Date: Mar. 30, 2023

(54) PNEUMATIC COMPRESSION SYSTEMS AND METHODS

(71) Applicant: Hyper Ice, Inc., Irvine, CA (US)

(72) Inventors: John Parker Northrup, Hanson, MA (US); Jonathan Clyde Stump, Cambridge, MA (US); Gilad Jacobs, Newton, MA (US)

(21) Appl. No.: 17/727,084

(22) Filed: Apr. 22, 2022

Related U.S. Application Data
(60) Provisional application No. 63/248,077, filed on Sep. 24, 2021.

(51) Int. Cl. A61H 9/00

(52) U.S. Cl. CPC A61H 9/0092; A61H 9/0007; A61H 2201/5097; A61H 2201/1207; A61H 2201/5043; A61H 2205/106

(57) ABSTRACT

Disclosed herein are systems for applying pneumatic compression to a portion of a body comprising: a wrap comprising at least two air bladders; and a control unit. The control unit is configured to control the air pressure in the at least two air bladders. The control unit includes an electro-mechanically autonomous system configured to achieve synchronization between the wrap and one or more additional wraps.

### CROSS REFERENCE TO RELATED APPLICATIONS

This application claims priority to U.S. Provisional Application No. 63/248,077, filed on Sep. 24, 2021. The foregoing application is incorporated by reference herein in its entirety and for all purposes.

### FIELD

The present disclosure is related to the field of pneumatic compression, and, more particularly, to portable and wearable intermittent pneumatic compression systems (e.g., air compression wraps).

### BACKGROUND

Pneumatic compression, or dynamic compression, uses therapeutic, controlled external compression cycles to help prevent blood clots in the deep veins of limbs (e.g., legs). An intermittent pneumatic compression device may use cuffs around the legs to squeeze the legs by intermittently inflating and deflating with particular cycle times and pressures, resulting in increased blood flow through the veins of legs, which may help prevent blood clots. Pneumatic compression may also be used for the treatment of lymphedema or chronic venous insufficiency with venous stasis ulcers. Pneumatic compression may also be used to reduce edema and aid return of venous blood to the heart.

Conventional pneumatic compression treatment systems are generally large devices that require a user to remain in a stationary position during use. There is a need for an improved device that allows for treatment while a user is ambulatory and/or that can be easily packed or relocated during travel.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

The inventions disclosed herein include dynamic air compression systems and associated methods that can be used as massagers, e.g., to temporarily relieve minor muscle aches and/or pains and to temporarily increase circulation to the treated areas. Example benefits of the systems and methods include the temporary relief of minor muscle aches and pains, and increased circulation in the area being treated.

In general, in one aspect, embodiments of the present invention relate to a system for applying pneumatic compression to a portion of a body. The system can include a wrap including at least two air bladders, and a control unit, where the control unit is configured to control the air pressure in the at least two air bladders. In various embodiments, the system runs a treatment algorithm to generate pulsing sensation from at least part of the at least two air bladders to skin. The system can also include one or more additional wraps including at least two air bladders, and one or more additional control units, where the control unit and the one or more additional control units are configured to allow synchronous control between the wrap and the one or more additional wraps using radio frequency (RF) communication. In various embodiments, the at least two air bladders include overlapping areas between adjacent air bladders. In various embodiments, at least two air bladders refer to at least two distinct casings or bladders. In various embodiments, at least two air bladders refer to a single outer casing or bladder that includes at least two distinct compartments (or chambers). In various embodiment, an air bladder refers to any compartment capable of being independently inflated and/or deflated.

In various embodiments, the wrap includes at least one of a calf wrap, a foot wrap, an ankle wrap, a shoulder wrap, an arm wrap, a thigh wrap, a knee wrap, a forearm wrap, an elbow wrap, a bicep wrap, an upper arm wrap, and a shoulder wrap. The wrap can also include an outer layer including means to (i) fasten the wrap to a user and (ii) force pressure from the at least two air bladders toward the user; and an inner layer close to or in contact with a skin surface of the user, where the at least two air bladders are disposed between the outer layer and the inner layer.

In various embodiments, the control unit includes at least one of a compressor, a plurality of solenoid valves, a battery, a printed circuit board (PCB), a battery charging interface, a user interface, and a programming interface, and wherein the battery charging interface is a USB-C charging port. The plurality of solenoid valves are configured to at least one of inflate or deflate the at least two air bladders. The compressor is a miniature DC compressor. The user interface includes at least one of a display, a pressure level button, a session time button, a start/stop button, a Bluetooth connection status indicator, an RF connection status indicator, and a battery status indicator. The display includes an organic light-emitting diode (OLED) display. The Bluetooth connection status indicator includes a blue LED to light up when connected to a mobile device. The control unit can also include a Bluetooth chip to achieve Bluetooth connection between the system and a mobile device.

In general, in another aspect, embodiments of the present invention relate to a system for applying pressure to a portion of a body. The system can include a first body wrap comprising a first plurality of air bladders, a first control unit disposed on the first body wrap, a second body wrap including a second plurality of air bladders, and a second control unit disposed in the second body wrap, where the first control unit and the second control unit include electro-mechanically autonomous systems configured to achieve synchronization between the first plurality of air bladders and the second plurality of air bladders. In various embodiments, the synchronization is achieved by RF communication between the first plurality of air bladders and the second plurality of air bladders.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments, in various combinations and permutations. without departing from the scope of any of the present inventions. As can be appreciated from the foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate various embodiments and together with the general description given above and the detailed description of the embodiments given below serve to explain and teach the principles described herein.

FIG. 1 is a schematic, perspective view illustrating a series of wrap systems, according to various embodiments.

FIG. 2A is a schematic, perspective view of a calf wrap system, according to various embodiments. FIGS. 2B-2D are schematic, perspective views of an air compression calf wrap as shown in FIG. 2A, according to various embodiments.

FIG. 3 is a block diagram of a calf wrap system, according to various embodiments.

FIG. 4 is a schematic, side view of an exemplary calf wrap including non-overlapping air bladders.

FIG. 5 is a schematic, side view of an exemplary calf wrap including overlapping air bladders, according to various embodiments.

FIG. 6 is a schematic, front view of an exemplary calf wrap including non-overlapping air bladders, according to various embodiments.

FIG. 7 illustrates a work flow to construct overlapping air bladders, according to various embodiments.

FIGS. 8A-H are an six schematic orthogonal and two schematic perspective views of the calf wrap of FIG. 7, according to various embodiments.

FIG. 9 is a schematic, side view of a miniature solenoid valve, according to various embodiments.

FIG. 10 is a graph of a treatment cycle of a wrap system, according to various embodiments.

FIG. 11A is a schematic diagram illustrating communication of treatment controls and synchronization of treatment between two calf wraps, according to various embodiments.

FIG. 11B is a schematic diagram illustrating communication of treatment controls between one calf wrap and a mobile device and synchronization of treatment between two calf wraps, according to various embodiments.

FIG. 11C is a schematic diagram illustrating communication of treatment controls, between one calf wrap and the mobile device, and between another calf wrap and the mobile device, and synchronization of treatment between two calf wraps, according to various embodiments.

FIGS. 12A-C are schematic, perspective views of a control unit, according to various embodiments.

FIGS. 12D-F are schematic, top view showing a display of the control unit of FIGS. 12A-C, according to various embodiments.

FIG. 13 illustrates a workflow for setting up personalized user controls in a wrap system, according to various embodiments.

FIG. 14 illustrates a workflow for setting up Bluetooth pairing (or connection) between a wrap system and a mobile device, according to various embodiments.

FIGS. 15A-15G illustrate a display showing battery status indicator showing battery statuses, according to various embodiments.

FIG. 16 illustrates a display showing an air leak message, according to various embodiments.

FIGS. 17-23 illustrate example constructions of a calf wrap, according to various embodiments.

FIGS. 24-33 illustrate example calf wraps and/or control units in use, according to various embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

As used throughout this specification, the words “upper,” “lower,” “longitudinal,” “upward,” “downward,” “proximal,” “distal,” “underneath,” and other similar directional words are used with respect to the views being described. It should be understood that the device described herein can be used in various orientations and is not limited to use in the orientations illustrated in the drawing figures.

As used throughout this specification, the words “intermittent pneumatic compression wrap,” “pneumatic compression wrap,” “air compression wrap,” “wrap,” “calf wrap,” and other similar words refer to a wrap that includes a plurality of inflatable and/or deflatable air bladders, which can be applied to specific area(s) of a person's body.

As described herein, the systems and methods in certain disclosed embodiments include one or more portable and wearable dynamic pneumatic compression wraps (or air compression wraps) configured to be integrated with Bluetooth technology as discussed further below, to include synchronized treatment between two or more air compression wraps, to include personized user controls, to be compact, and/or to be connected with mobile applications. In addition to the design, look, feel, and/or materials, the systems and methods in the present disclosed embodiments also include unique treatment algorithms managed by proper choice of valves and/or pneumatic routing, to achieve desirable user experience. The systems and methods in the present disclosed embodiments may benefit users such as athletes and office workers.

Furthermore, the systems and methods in certain disclosed embodiments use two-way Bluetooth and/or two-way radio frequency (RF) communication to allow two or more wrap systems and/or mobile device(s)) to connect to one another wirelessly, and to achieve the following exemplary advantages: 1) to drive treatment protocols and/or parameters in one or more wraps (e.g., on one or both legs of a user), wherein the treatment protocols and/or parameters are set via a mobile application in a mobile device; 2) to achieve synchronous control (e.g., synchronization of key events in a treatment algorithms) between two independent wraps in use, so that the same treatment protocols and/or events (e.g., the Pulse, Release, Hold, and Rest events as shown in Table 1) run simultaneously on both legs while each wrap is an autonomous systems (e.g., not connected by electric wires and/or pneumatic tubing; and 3) to achieve synchronous user control settings (e.g., personalized parameters) between two independent wraps (e.g., pressure level, treatment session time, and/or time to start or stop treatment). In some embodiments, the two-way Bluetooth and/or two-way radio frequency (RF) communication are wireless communication.

As described herein, the systems and methods in certain disclosed embodiments may focus on portable and wearable calf wraps using intermittent pneumatic compression technology. The muscles in the calves are important to a person's body as a natural pump to aid circulation and keep fluids moving through a person's lymphatic system, and the calf wraps in the present disclosed embodiments may be used to enhance the fluid movement and circulation in calves. However, in other embodiments, the concepts described herein can be applicable to wraps used on any suitable body portion.

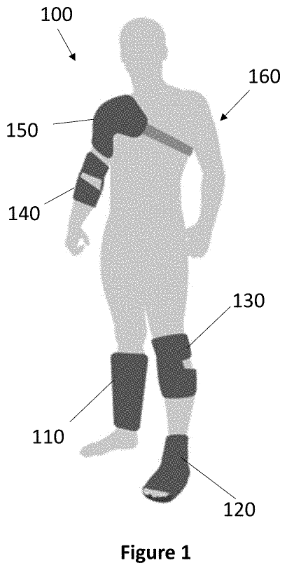

FIG. 1 illustrates a perspective view of a series of wrap system 100, according to aspects of the present embodiments. The wrap system 100 includes one or more air compression wraps (e.g., calf wrap 110, foot and/or ankle wrap 120, thigh and/or knee wrap 130, forearm and/or elbow and/or bicep wrap 140, and/or upper arm and/or shoulder wraps 150). The air compression wraps (110, 120, 130, 140, and/or 150) may be portable, wearable, Bluetooth enabled, able to integrate with a mobile application, and/or able to be synchronized to one another. For example, the air compression wraps (110, 120, 130, 140, and/or 150) may be portable to allow the user 160 to remain mobile while receiving treatment from the air compression wrap(s). In another example, the user 160 may take and/or use the air compression wraps (110, 120, 130, 140, and/or 150) in a plane, an office, sidelines, or dugout in addition to using them at home, a hotel room, a locker room, or a practice facility.

The one or more air compression wraps 110, 120, 130, 140, and/or 150 may be used to apply compression treatment (or therapy) on specific areas of the body (e.g., limbs and/or joints such as calves, feet, ankles, knees, thighs, elbows, arms, and/or shoulders) of a user 160 to improve circulation of blood in the specific areas, resulting in localized relief from discomfort due to e.g., inflammation, fluid-build up and/or muscle-fatigue. In some embodiments, the compression treatment is calibrated based on a particular user's biometric or physiological attributes (e.g., age, sex, weight, height, health condition, etc.) For example, a compression rate and/or force can be calibrated based on such attributes or any other suitable attribute.

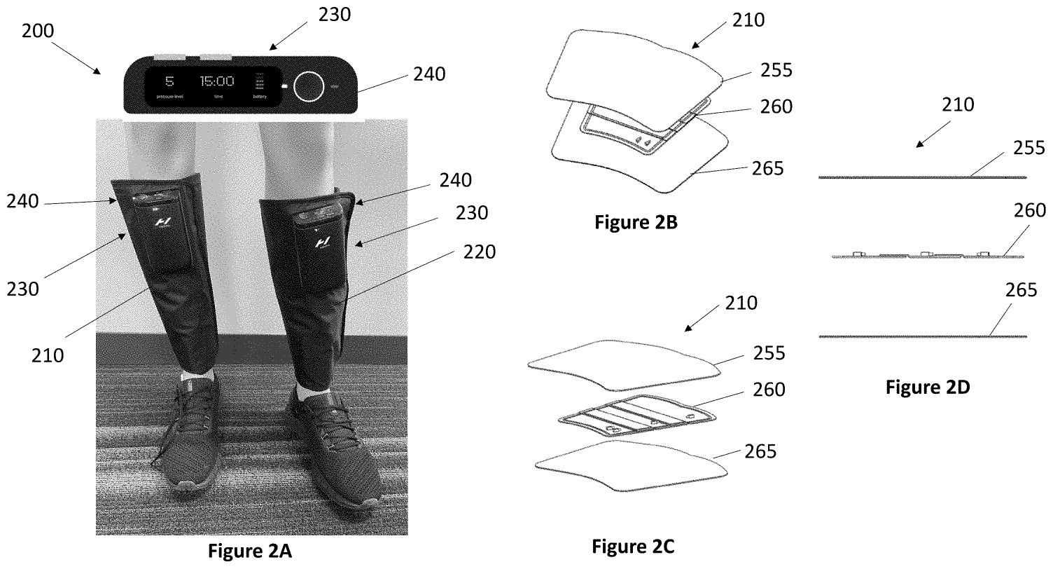

FIG. 2A is a perspective view of a calf wrap system 200, according to various embodiments. The air compression calf wrap system 200 may be used to enhance the fluid movement and circulation in calves of users such as athletes and office workers. The technology used in the air compression calf wrap system 200 may be applicable to other air compression wrap systems (e.g., foot and/or ankle wrap(s) 120, thigh and/or knee wraps 130, forearm wraps 140, and/or upper arm and/or shoulder wraps 150).

The calf wrap system 200 includes a pair of portable and/or wearable air compression calf wraps 210 and 220. In some embodiments, the calf wrap 210 or 220 may be made of durable, stretchable, and/premium materials. In some embodiments, the air compression calf wraps 210 and 220 may have an adjustable size and can fit a perimeter of calf up to 15 inches, 16 inches, 17 inches, 18 inches, 19 inches, or 20 inches.

As shown in FIG. 2A, each air compression calf wrap 210 or 220 can include a dedicated control unit 230 including a display 240. The control unit 230 may be operatively (e.g., electrically, pneumatically, and/or mechanically) connected with the air compression calf wrap (210 or 220) using a wired or wireless connection. In particular embodiments, the connection from the control unit to the air compression wrap is pneumatic, whereas the electronics are contained in the control unit 230. In particular embodiments, biometric sensors and/or thermal sensors may be used additionally in the system, resulting in an electrical connection between the control unit and the air compression wrap. In some embodiments, a mobile device (e.g., a smartphone) can replace and/or supplement the dedicated control unit 230.

FIGS. 2B-2D are schematic, perspective views of an air compression calf wrap as shown in FIG. 2A, according to various embodiments. As shown in FIGS. 2B-2D, the air compression calf wrap 210 or 220 includes an outer layer 255, an inner layer 265, and/or an air holding layer 260 (e.g., a multi-chamber air holding layer) disposed between the outer layer 255 and the inner layer 265, as described further in detail below.

The outer layer 255 may include a durable, attractive material with limited ability to stretch for forcing the pressure from the air bladder(s) inward toward the user's limb (e.g., calf). In some embodiments, the outer layer 255 may include a surface (or a mounting plate) to mechanically affix the control unit 230. In some embodiments, the outer layer 255 may include means (e.g., hook-and-loop and/or other suitable means) for the air compression calf wrap 210 or 220 to fasten tightly and/or be secured to the limb (e.g., calf) without becoming loose or slipping down the limb (e.g., calf).

The inner layer 265 may include materials that are comfortable to the skin, cleanable (e.g., having the ability to be wiped down or disinfected), anti-odor, anti-microbial, anti-fungal, moisture-wicking, durable, and/or thermally stable (e.g., not too hot, and/or not too cold). In some embodiments, the inner layer 265 can include nylon. In some embodiments, the inner layer 265 includes a breathable spacer mesh. For example, the breathable spacer mesh may replace the nylon material. As another example, the breathable spacer mesh may be added on the nylon material as a removable, washable liner.

In some embodiments, the outer layer 255 includes the same material as the inner layer 265 while in other embodiments, the outer layer 255 includes a different material as the inner layer 265 to enhance the performance and user experience of the air compression calf wrap 210 or 220.

In particular embodiments, the inner layer 265 and/or the outer layer 255 include highly durable materials such as 200-210 Denier Nylon Diamond Ripstop Material and/or a 4 mil TPU coating with enhancement additives to achieve properties such as durable water repellent (DWR), anti-microbial, non-latex, and/or non-AZO.

In use, in addition to providing a reactive force for the compressible air bladder, the outer layer 255 may also be used to contain and/or protect the plurality of air bladders included in the multi-chamber air-holding layer 260. In use, the inner layer 265 may be used to rest against the skin or clothing of the user.

In particular embodiments, the inner layer 265 and/or the outer layer 255 of the calf wrap can include a combination of neoprene fabric and nylon material to house the multi-chamber air-holding layer 260 and/or bladders. For example, a portion of the inner layer 265 may include neoprene fabric and other portions of the inner layer 265 and the outer layer 255 may include nylon. Advantageously, the use of neoprene can allow a user to affix the calf wrap tightly around the limb as it stretches and forms according to the user's physiology.

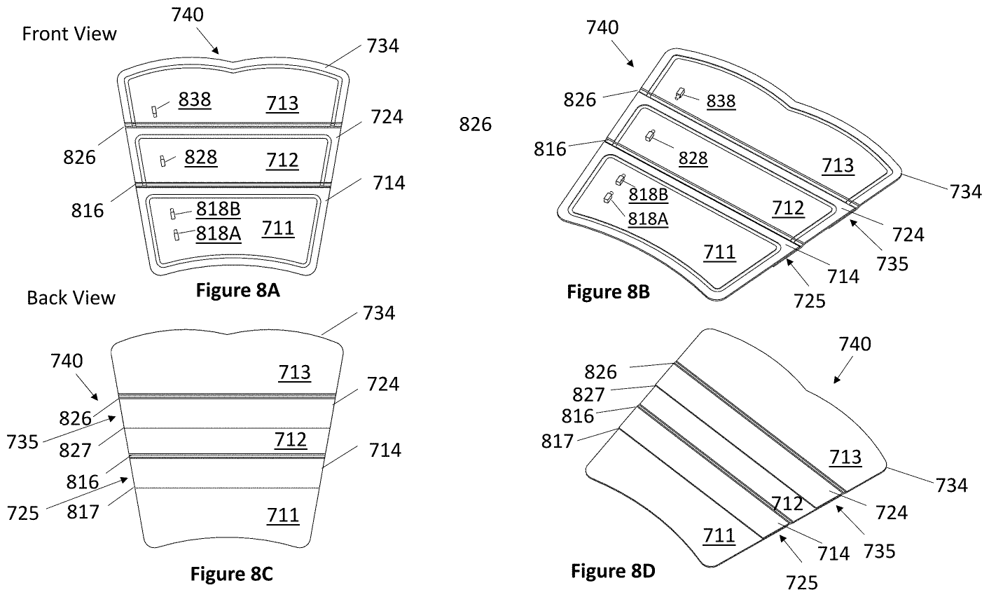

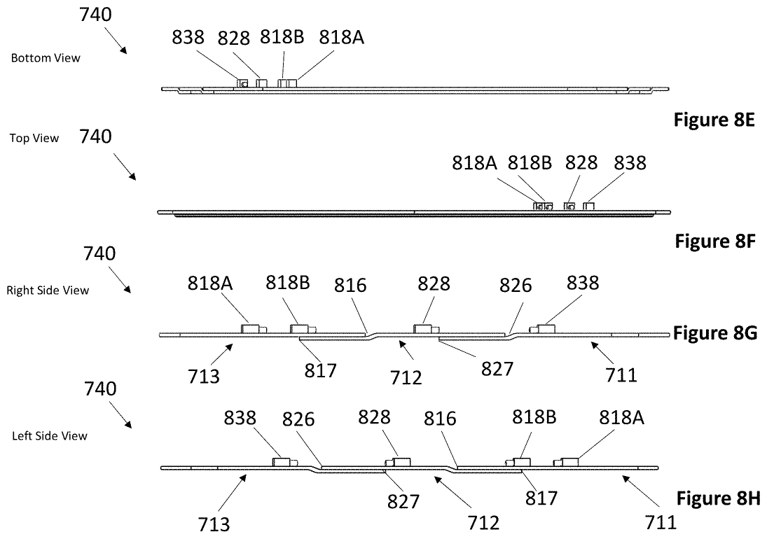

The multi-chamber air-holding layer 260 can include a plurality of (e.g., two, three, four, five, six, seven, eight, or more) air bladders (or chambers, zones) that may not be directly visible to a user. The plurality of air bladders may include airtight seal(s) to ensure that air in the air bladders does not leak from the air bladders when the air compression wrap 210 or 220 is in use. The air bladder(s) may be operatively connected with the control unit 230 by using suitable fittings and/or tubing to achieve intermittent pneumatic compression treatment. In some embodiments, the individual air chambers/zones are created by separate bladders. In other embodiments, the individual air chambers/zones are created by stays formed in a single larger bladder. Stays are well known to those skilled in the art, but generally include portions of the bladder wall that are sealed together in order to form separate chambers/zones. The multi-chamber air-holding layer 260 is discussed in further detail in relation to FIGS. 7 and 8.

The control unit 230 can include or house various electro-mechanical components to drive the system 200, including, for example, a miniature DC compressor, a plurality of (e.g., 2, 3, 4, 5, 6, 7, 8, or more) solenoid valves (or manifolds), a pressure sensor, a battery, a battery charging interface (or power jack), a printed circuit board (PCB), Bluetooth Low Energy (BLE) components, a user interface, a programming or debugging interface (e.g., Bluetooth, USB or other serial communication port for manufacturing and/or service). In particular embodiments, the battery charging interface is a USB-C charging port with a cover (e.g., rubber-like material) for ingress protection. The cover may be tethered to the enclosure of the USB-C charging port so that it doesn't get lost when the cover is removed (e.g., for accessing the USB-C port). In particular embodiments, the debugging interface is managed by a Bluetooth connection. In particular embodiments, the debugging interface cam be managed by a USB connection. The control unit 230 may be compact, light-weight, wireless, and/or Bluetooth-enabled. In some embodiments, the control unit may comprise a length in a range from 0.5 inch to 6 inches and/or a weight in a range up to 8 oz, 9 oz, 10 oz, 11 oz, or 12 oz. In particular embodiments, the control unit comprises a size of 4.75 inches×2.75 inches×1 inch.

In some embodiments, the control unit 230 may be used to enable Bluetooth connection between the system 200 and a mobile device using a mobile application. The Bluetooth feature may enhance user's experience. For example, the user may set up personalized parameters or protocols, synchronize, and/or control one or both calf wraps 210, 220 via the mobile application. An example mobile application is described in U.S. patent application Ser. No. 17/372,237, which is incorporated by reference herein in its entirety.

The calf wrap system 200 can further include a charger to charge the air compression calf wraps 210 and/or 220. In some embodiments, the charger includes a blade adaptor kit. In some embodiments, the charger is a world-voltage capable charger to enable the charge of the calf wrap worldwide. In some embodiments, the charger includes one or more USB ports. In particular embodiments, the charger is world voltage capable with blade adaptors, and includes two USB ports to charge both calf wraps from a single charger.

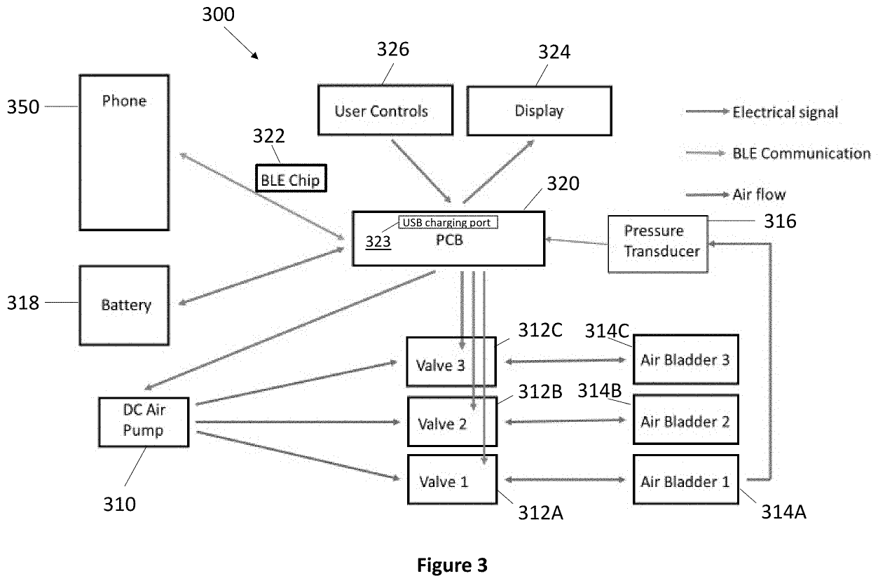

FIG. 3 is a block diagram of a calf wrap system 300, according to various embodiments. The calf wrap system 300 includes electro-mechanical components including a miniature DC air compressor (or pump) 310, a plurality of (e.g., two, three, four, five, six, seven, eight, or more) solenoid valves (or manifolds) 312A, 312B, 312C, a pressure sensor (or pressure transducer) 316, a battery 318, a battery charging interface (or power jack) (not shown), a printed circuit board (PCB) 320, Bluetooth Low Energy (BLE) components (e.g., a BLE chip 322), a display 324, a minimal user interface 326 (e.g., for user controls), a programming or debugging interface (e.g., USB charging port 323 or other serial communication port for manufacturing or service; not shown). In some embodiments, the PCB 320 includes at least one microcontroller unit (MCU). In some embodiments, the calf wrap system 300 may be configured differently with additional or fewer components. For example, BLE chip 322 need not be a separate component, but instead may be included in the PCB 320.

The calf wrap system 300 further includes a plurality of (e.g., two, three, or more) air bladders 314A, 314B, 314C operatively connected with the plurality of (e.g., two, three, or more) miniature solenoid valves (or manifolds) 312A, 312B, 312C, respectively. In some embodiments, the calf system 300 may include one or more additional valves (not shown) to check and/or protect the calf system 300 against over-inflating. In some embodiments, the pressure sensor 316 may be operatively connected with an air bladder (e.g., the most distal air bladder 314A) to monitor and/or measure the pressure in the air bladder(s) when the calf wrap system 300 is running (e.g., inflation and/or deflation). In some embodiments, BLE communication may be paired between the PCB 320 and a mobile phone 350 using the BLE chip 322.

In use, the calf wrap system 300 may generate electrical signals, BLE communications, and/or air flows among at least some of the components in the calf wrap system 300, as discussed further below.

In use, the PCB 320 may receive electrical signals from the user controls 326 (e.g., to start, run, pause, or stop), the pressure sensor 316, and the battery 318. The PCB 320 then sends electrical signal(s) to the miniature DC compressor (or DC air pump) 310, the solenoid valves (or manifolds) 312A, 312B, 312C, and/or the display 324 to operate accordingly. For example, when a user presses a power button to start the calf wrap system 300, an electrical signal may be received by the PCB 320 from the power button. The PCB 320 may then send an electrical signal to light up the display 324 and show the system 300 is in the Ready state.

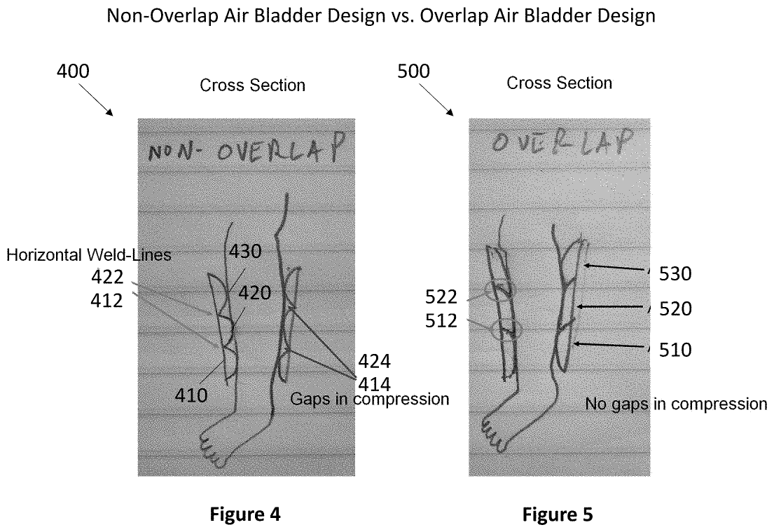

FIG. 4 is a schematic, side view of an exemplary calf wrap 400 including non-overlapping air bladders. Referring to FIG. 4, the calf wrap 400 includes a plurality of (e.g., three) air bladders 410, 420, 430 constructed by placing two pieces of materials together and sealing the two pieces of materials at weld lines 412 and 422. When the non-overlapping air bladders 410, 420, 430 are inflated, the weld lines 412, 422 may result in gaps 414, 424 between adjacent air bladders 410, 420, 430, leading to no compression from the inflated bladders to the skin in the gaps 414, 424.

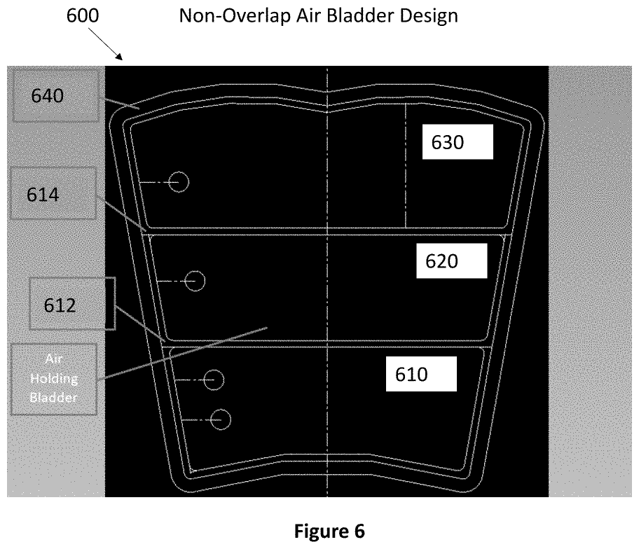

FIG. 5 illustrates schematic view of a calf wrap 500 including overlapping air bladders, according to aspects of the present embodiments.

Referring to FIG. 5, the calf wrap 500 includes a plurality of (e.g., three) overlapping air bladders 510, 520, 530. In some embodiments, the calf wrap 500 may be constructed by placing (e.g., folding) a plurality of (e.g., two, three, or more) individually sealed air bladders together using excess material (e.g., non-air-holding material) so that adjacent air bladders include an overlapping area 512, 522. In contrast to the calf wrap 400, when the overlapping air bladders 510, 520, and 530 are inflated, the overlapping areas 512, 522 may minimize or eliminate the gaps 414, 424 that could exist between non-overlapping air bladders (FIG. 4). Accordingly, compared with the system 400, the overlapping configuration of the calf wrap 500 may result in minimized loss of compression from the air bladders to the skin, improved performance, and/or better user experience.

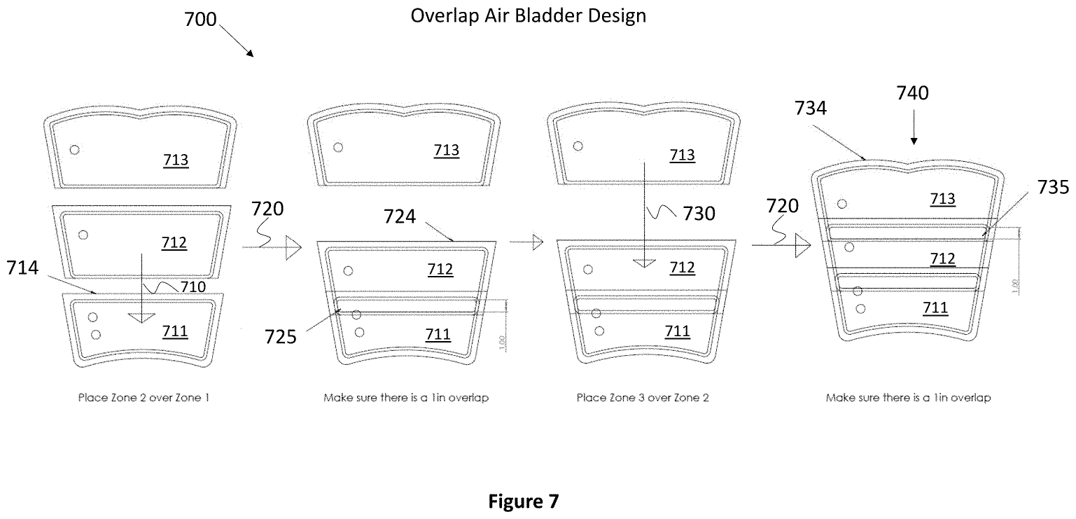

FIG. 6 is a schematic, front view of an exemplary calf wrap 600 including non-overlapping air bladders. The calf wrap 600 may be constructed by cutting two pieces of material having the same area, placing one piece on top of the other piece, and welding (e.g., radio-frequency welding) both pieces together to generate three airtight zones (or chambers) 610, 620, 630, which are non-overlapping air bladders. The welding lines 612, 614 between adjacent non-overlapping chambers (or zones) may cause gaps between adjacent bladders when the air bladders are inflated, resulting in no compression being applied in parts of the skin, as discussed above with reference in FIG. 4. In some embodiments, the calf wrap 600 may further include a piece of excess material 640 to hold or protect the three air bladders 610, 620, 630 together.

FIG. 7 illustrates a work flow 700 to construct a calf wrap 740 including overlapping air bladders, according to various embodiments. The calf wrap 740 includes three individual air bladders 711, 712, 713 attached longitudinally. Each air bladder 711, 712, or 713 is sealed on a piece of excess materials 714, 724, 734 to secure to fabric and/or to form overlapping areas, as discussed in further detail below. Example air bladders are discussed in Example 1.

At step 710, the piece of excess material 714 is attached (e.g., sewn) to the top edge of the air bladder 711 to secure to fabric of the air bladder 711. In particular embodiments, the fabric is 200 denier nylon and/or Thermoplastic Polyurethane (TPU).

At step 720, the bottom area of the bladder 712 is attached (e.g., sewn) to (e.g., behind or over) the top area of the excess material 714 to generate an overlapping area 725 between the adjacent air bladders 711 and 712.

At step 730, the bottom area of the bladder 713 is attached (e.g., sewn) to (e.g., behind or over) the top area of the bladder 712 to generate an overlapping area 735 between the adjacent air bladders 712 and 713.

In some embodiments, a perimeter of lines are sewn to the top of bladder 713 to form/constrain the edges of the bladders. Details of construction is further discussed in Example 1.

At step 740, the overlapping areas 725, 735 may be measured to ensure that each of the overlapping areas include a width. In some embodiments, the width is at least 0.1 inch, 0.5 inch, 1 inch (or 2.5 cm), 1.5 inches, 2 inches, 3 inches, 4 inches, 5 inches, or 10 inches.

FIG. 8A is an schematic, front view of the calf wrap 740, according to various embodiments. FIG. 8B is a schematic, perspective view of the calf wrap 740, according to various embodiments. FIG. 8C is a schematic, rear view of the calf wrap 740, according to various embodiments. FIG. 8D is a schematic perspective view of the calf wrap 740, according to various embodiments. FIG. 8E is a schematic, bottom view of the calf wrap 740, according to carious embodiments. FIG. 8F is a schematic, top view of the calf wrap 740, according to various embodiments. FIG. 8G is a schematic, right side view of the calf wrap 740, according to various embodiments. FIG. 8H is a schematic, left side view of the calf wrap 740, according to aspects of the present embodiments.

Referring to FIGS. 8A-8H, the calf wrap 740 includes a plurality of (e.g., two, three, or more) individual air bladders 711, 712, 713, and the overlapping areas 725, 735 between respective adjacent air bladders, as discussed in FIG. 7. The plurality of individual air bladders 711, 712, 713 can attached together by using pieces of excess materials (e.g., non-air-holding material) 714, 724, 734, respectively.

In some embodiments, the bottom area of the air bladder 712 may be disposed on the top edge of the air bladder 711, resulting in an overlapping area between the two air bladders 711, 712. Similarly, the bottom area of the air bladder 713 may be attached to the top edge of the air bladder 712, resulting in an overlapping area between the two air bladders 712, 713.

Referring to FIGS. 8A, 8B, and 8E-8H, the air bladder 711 may include at least two flanges 818A and 818B operatively attached to the air bladder 711.

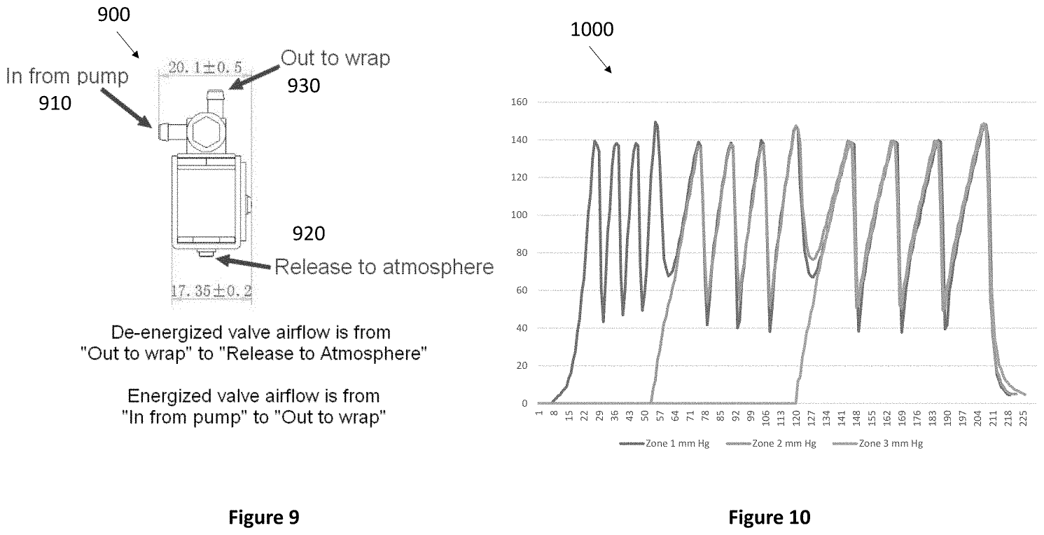

As used herein, a flange a connector, or a fitting refers to a passive component that acts as a passage for the air to flow in and out of a sealed air holding space (e.g., an air bladder 711, 712 or 713). In some embodiments, a flange may include two openings, wherein one opening is welded into the air bladder and the other opening may to be attached to a tubing and/or a valve (e.g., valve 900 in FIG. 9). In some embodiments, the opening(s) of a flange is barbed when in use.

In various embodiments, The flange 818A or 818B may be used to attach to a valve (e.g., valve 900 in FIG. 9) for the valve to direct air flows from an air compressor or pump (e.g., the miniature DC air compressor 310 in FIG. 3) to the air bladder 711 for inflating the air bladder 711, to seal air (e.g., to enable air to be held) in the air bladder 711 for holding the air pressure in the air bladder 711, and/or to direct air flows from the air bladder 711 to atmosphere for deflating the air bladder 711. In various embodiments, the flange 818A or 818B may be used to direct air flows from the air bladders to the pressure sensor (e.g., the pressure sensor 316 in FIG. 3) for measuring, recording, and/or monitoring the air pressure in the air bladder 711. In some embodiments, one flange 818A or 818B is used for inflating the bladder 711 and for deflating the bladder 711. In some embodiments, one flange of the flanges 818A and 818B is used for inflating the bladder 711 and the other flange of the flanges 818A and 818B is used for deflating the bladder 711.

Referring still to FIGS. 8A, 8B, and 8E-8H, the air bladders 712 may include a flange 828 operatively attached to the front area of the air bladders 712. The flange 828 may be used to inflate, to hold air, and/or to deflate the air bladder 712.

Referring still to FIGS. 8A, 8B, and 8E-8H, the air bladders 713 may include a flange 838 operatively attached to the front area of the air bladders 713. The flange 838 may be used to inflate, to hold air, and/or to deflate the air bladder 713.

Referring to FIGS. 8A-8D, the calf wrap 740 can include edges (or lines) and overlapping areas of the air bladders 711, 712, and/or 713, as described herein. A line 816 may be the top edge of the air bladder 711. A line 817 may be the bottom edge of the air bladder 712. A line 826 may be the top edge of the air bladder 712. A line 827 may be the bottom edge of the air bladder 713. An overlapping area 725 may be between the line 817 and the line 816. An overlapping area 735 may be between the line 827 and the line 826.

FIG. 9 is a side view of a solenoid valve 900, according to aspects of the present embodiments. For example, the valve 900 may be equivalent to the solenoid valve 312A, 312B, or 312C described in FIG. 3. As another example, the valve 900 may be connected to the flanges 818A, 818B, 828, and/or 838 in FIG. 8. The valve 900 includes a plurality of ports 910, 920, 930. The port 910 may be operatively connected with an air compressor and operated to receive an air flow from an air compressor during inflation of the air bladder. The port 920 may be connected with atmosphere and operated to release air to atmosphere. The port 930 may be operatively connected with the air bladder and operated for one or more purposes: 1) to release air (e.g., energized air flows) from the compressor to the air bladder (i.e., inflation); and 2) to receive air (e.g., de-energized air flows) from the air bladder (i.e., deflation). In some embodiments, an energized valve airflow may move from the port 910 to the port 930 for inflating the air bladder, while a de-energized valve airflow may move from the port 930 to the port 920 for deflating the air bladder.

In some embodiments, the valve 900 may be used for pressure measurement in one or more air bladders (e.g., air bladders 711, 712, and/or 713 in FIGS. 7, 8A-8D). In this case, the port 930 may be operatively connected with the air bladder, the port 920 may be operatively connected with atmosphere, and the port 910 may be operative connected with air compressor (or pump). Additionally, flanges (e.g., 818A or 818B in FIG. 8) may be connected to the pressure sensor (e.g., via pneumatic tubing). During the pressure measurement, the port 920 may be closed, and the ports 910 and 930 may be open to direct an air flow from the air compressor to the air bladder and in parallel from 818A (or 818B) to the pressure sensor for measurement. In some embodiments, the flanges are operatively connected to any one of the air bladders. In particular embodiments, the flanges are operatively connected to the bottom air bladder (e.g., air bladder 711 in FIGS. 7 and 8). Therefore, if the treatment algorithm always include operating the bottom air bladder (e.g., air bladder 711 in FIGS. 7 and 8), the pressure sensor can measure the pressures in one or more air bladders (e.g., air bladder 711, 712, and/or 713 in FIGS. 7 and 8).

In some embodiments, the port 910, 920, and/or 930 includes a diameter from about 1 mm to about 20 mm. In some embodiments, the port 910, 920, and/or 930 includes a diameter from about 1 mm to about 10 mm. In some embodiments, the port 910, 920, and/or 930 includes a diameter from about 1 mm to about 5 mm. In some embodiments, the port 910, 920, and/or 930 includes a diameter from about 2 mm to about 5 mm.

In some embodiments, the valve 900 includes a width from 1 mm to 50 mm. In some embodiments, the valve 900 includes a width from 1 mm to 40 mm. In some embodiments, the valve 900 includes a width from 1 mm to 30 mm. In some embodiments, the valve 900 includes a width from 5 mm to 30 mm. In some embodiments, the valve 900 includes a width from 5 mm to 25 mm. In particular embodiments, the valve 900 includes a width of 19.6 mm. In particular embodiments, the valve 900 includes a width of 20.6 mm.

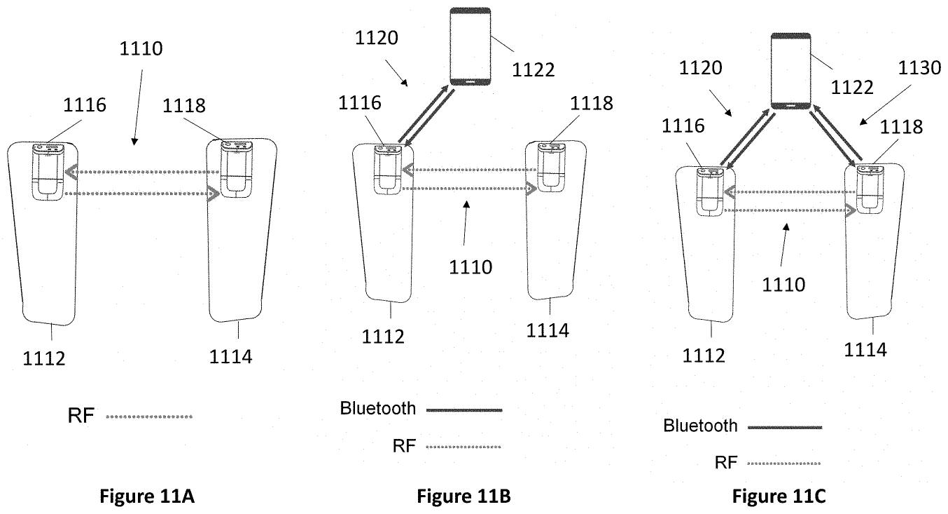

FIG. 10 illustrates a graph of an exemplary treatment cycle 1000 of the wrap system as discussed above, according to various embodiments. The treatment cycle 1000 may be based on a treatment algorithm to control the pressure in the air bladders.

An example treatment algorithm(s) of various embodiments include a plurality of events (or modes) as shown in Table 1 below. The values shown in Table 1 are for a single example treatment algorithm and the skilled person will understand that other times and order of stens can be used in various other embodiments.

TABLE 1
Treatment Algorithm Events (or Modes)

| Event | Event | Move to | | | | |
|---|---|---|---|---|---|---|
| Number | Description | Next Event | Compressor | Valve 1 | Valve 2 | Valve 3 |
| 0 | Off/Idle | Start Button | 0 | 0 | 0 | 0 |
| 1 | V1 Pulse Inflate | Pressure | 1 | 1 | 0 | 0 |
| 2 | V1 Pulse Hold | Time 1 | 0 | 1 | 0 | 0 |
| 3 | V1 Pulse Release | Time 2 | 0 | 0 | 0 | 0 |
| 4 | Loop V1 Pulse | — | — | — | — | — |
| | Events × 3 | | | | | |
| 5 | V1 Hold Inflate | Pulse Inflate | 1 | 1 | 0 | 0 |
| | | Pressure + | | | | |
| | | 10 mm Hg | | | | |
| 6 | V1 Hold | Time 3 | 0 | 1 | 0 | 0 |
| 7 | V1; V2 Pulse | Pressure | 1 | 1 | 1 | 0 |
| | Inflate | | | | | |
| 8 | V1; V2 Pulse | Time 1 | 0 | 1 | 1 | 0 |
| | Hold | | | | | |
| 9 | V1; V2 Pulse | Time 2 | 0 | 0 | 0 | 0 |
| | Release | | | | | |
| 10 | Loop V1; V2 | — | — | — | — | — |
| | Pulse Events × 3 | | | | | |
| 11 | V1; V2 Hold | Pulse Inflate | 1 | 1 | 1 | 0 |
| | Inflate | Pressure + | | | | |
| | | 10 mm Hg | | | | |
| 12 | V1; V2 Hold | Time 3 | 0 | 1 | 1 | 0 |
| 13 | V1; V2; V3 | Pressure | 1 | 1 | 1 | 1 |
| | Pulse inflate | | | | | |
| 14 | V1; V2: V3 | Time 1 | 0 | 1 | 1 | 1 |
| | Pulse Hold | | | | | |
| 15 | V1; V2; V3 | Time 2 | 0 | 0 | 0 | 0 |
| | Pulse Release | | | | | |
| 16 | Loop V1; V2; | — | — | — | — | — |
| | V3 Pulse | | | | | |
| | Events × 3 | | | | | |
| 17 | V1; V2; V3 | Pulse Inflate | 1 | 1 | 1 | 1 |
| | Hold Inflate | Pressure + | | | | |
| | | 10 mm Hg | | | | |
| 18 | V1; V2; V3 Hold | Time 3 | 0 | 1 | 1 | 1 |
| 19 | Rest | Time 4 | 0 | 0 | 0 | 0 |

0 = De-energized/Off
1 = Energized/On

Referring to Table 1, multiple variables representing time intervals (e.g., Time 1, Time 2, Time 3, and/or Time 4) are used (e.g., for providing flexibility in user customization of the treatment). “Time 1” refers to a first time interval. “Time 2” refers to a second time interval. “Time 3” refers to a third time interval . “Time 4” refers to a fourth time interval.

In some embodiments, Time 1, Time 2, Time 3, and/or Time 4 is between 0.1 and 100 seconds. In some embodiments, Time 1, Time 2, Time 3, and/or Time 4 is at least 0.1 second, 0.2 second, 0.3 second, 0.4 second, 0.5 second, 0.6 second, 0.7 second, 0.8 second, 0.9 second, 1 second, 1.5 second, 2 seconds, 2.5 seconds, 3 seconds, 4 seconds, 5 seconds, 6 seconds, 7 seconds, 8 seconds, 9 seconds, 10 seconds, 25 seconds, 50 seconds, 75 seconds, or 100 seconds. In particular embodiments, Time 1, Time 2, and Time 3 are 2 seconds, and Time 4 is 10 seconds.

In some embodiments, there is a time delay between the actuation of the compressor and the actuation of the valve. In some embodiments, the time delay is between 0.01 and 10 seconds. In some embodiments, the time delay is at least 0.01 second, 0.05 second, 0.1 second, 0.2 second, 0.3 second, 0.4 second, 0.5 second, 0.6 second, 0.7 second, 0.8 second, 0.9 second, 1 second, 1.5 second, 2 seconds, 2.5 seconds, 3 seconds, 4 seconds, 5 seconds, 6 seconds, 7 seconds, 8 seconds, 9 seconds, or 10 seconds.

Referring to Table 1, valve 1 may be used to control the pressure of air bladder 1, valve 2 may be used to control the pressure of air bladder 2, and valve 3 may be used to control the pressure of air bladder 3. “0” refers to a de-energized state or an OFF state of one of the compressor, valve 1, valve 2, or valve 3 at an event; “1” refers to an energized state or an ON state of one of the compressor, valve 1, valve 2, or valve 3 at an event. In some embodiments, the ON state lasts for one of Time 1, Time 2, Time 3, or Time 4. In some embodiments, the ON state lasts for “Pressure,” wherein “Pressure” refers to a time when a pre-determined pressure is achieved. For example, “Pressure” refers to an inflation time (e.g., in event 1, 7, or 13) that varies depending on factors such as the pressure and/or volume of an air bladder.

As shown in Table 1, for an event that include “1” for two or more of the compressor, valve 1, valve 2, or valve 3, the total time interval of the event is a sum of the time intervals for each of the two or more of the compressor, valve 1, valve 2, or valve 3. For example, air bladder 1 is inflated in event 1, which is represented by “1” for the compressor and valve 1 and “0” for valve 2 and valve 3. In comparison, air bladders 1 and 2 are inflated during event 7, represented by “1” for the compressor, valve 1, and valve 2, and “0” for valve 3. Therefore, the time of inflation during event 7 (and followed by events 8-12) is longer than that the time of inflation during event 1 (and followed by events 2-6) because more time may be needed to achieve pressure in inflating the volume of two bladders 1 and 2 than inflating the volume of a single bladder 1. As another example, air bladders 1, 2 and 3 are inflated in event 13, represented by “1” for the compressor, and three valves 1-3. Therefore, the time of inflation during event 13 (and followed by events 14-19) is longer than that the time of inflation during event 7 (and followed by events 8-12) because more time may be needed to achieve pressure in inflating the volume of three air bladders 1-3 than inflating the volume of two air bladder 1 and 2.

In this example, Zone 1 refers to the zone inside the most distal air bladder (e.g., the air bladder 711 in FIGS. 7 and 8). Zone 2 refers to the zone inside the next neighboring air bladder (e.g., the air bladder 712 in FIGS. 7 and 8) proximal to Zone 1. Zone 3 refers to the zone inside the next neighboring air bladder (e.g., the air bladder 713 in FIGS. 7 and 8) proximal to Zone 2.

In some embodiments, the wrap system includes only two air bladders in total, Zone 1 and Zone 2. In this case, the air bladder in Zone 2 is the most proximal air bladder.

In some embodiments, the wrap system includes three air bladders in total. In this case, Zone 3 is the most proximal air bladder (e.g., the air bladder 713 in FIGS. 7 and 8).

In some embodiments, the wrap system includes more than three air bladders in total. In this case, the air bladder in Zone 3 may not be the most proximal air bladder. For example, if the wrap system includes four air bladders in total, then the air bladder in Zone 4 refers to the most proximal air bladder.

Referring still to Table 1, “Valve 1” refers to the valve to control air pressure in Zone 1. “Valve 2” refers to the valve to control air pressure in Zone 2. “Valve 3” refers to the valve to control air pressure in Zone 3. Similar concepts can apply for embodiments with more than three zones and/or more than three valves.

Referring still to Table 1 and FIG. 10, each event (or mode) of the treatment algorithm/cycle 1000 is discussed further in detail below. The below description of events is merely one example and the skilled person will understand that adjustments can be made in other embodiments.

At Event 0, the wrap system is in the OFF or idle (e.g., Ready) state. The valves in all bladders and the compressor are in the OFF state. In some embodiments, the OFF (or not energized) state of a valve refers to the valve opening airpath between the corresponding airbladder of the wrap system to atmosphere, allowing the corresponding air bladder(s) to de-pressurize when a treatment is stopped or the wrap system is in the Off state. Pressing the start button may cause the treatment moves to the next event (e.g., event 1).

At Event 1, the compressor is in the ON state. Valve 1 is energized, opening airway from the compressor to the air bladder in zone 1 (that is, the most distal air bladder) (e.g., the air bladder 711 in FIGS. 7 and 8) and closing path to atmosphere in order to pressurize the air bladder in Zone 1. The pressure sensor is in the ON state to monitor the pressure in Zone 1 to achieve the “Pulse Inflate” target pressure. Once target pressure is achieved, the treatment moves to the next event (e.g., event 2).

At Event 2, the compressor is in the OFF state. Valve 1 is energized, closing path to atmosphere so that air bladder does not lose pressure. The wrap system starts an internal time count (that is, Time 1). Once the time count is achieved, the treatment moves to the next event (e.g., event 3).

At Event 3, the compressor is in the OFF state. Valve 1 is de-energized, opening path to atmosphere in order to de-pressurize Zone 1. The wrap system starts an internal time count (that is, Time 2). Once the time count is achieved, the treatment moves to the next event (e.g., event 4).

The above Event numbers 1-3 may create the “pulsing” sensation of compression at the skin surface that contacts Zone 1.

At Event 4, the Event numbers 1-3 repeats as a loop for a plurality of times (e.g.

two, three, or more times) based on a setting from the user. Once the Event numbers 1-3 have occurred the number of repetitions the user sets (e.g., three times), the treatment moves to next event (e.g., event 5).

At Event 5, the compressor is in the ON state. Valve 1 is energized, opening airway from the compressor to Zone 1 and closing path to atmosphere in order to pressurize

Zone 1. The pressure sensor is in the ON state to monitor the pressure in Zone 1 to achieve the “Hold Inflate” target pressure that equals to the “Pulse Inflate” target pressure (e.g., in Event 1)+10 mm Hg. For example, if the “Pulse Inflate” target pressure is 80 mm Hg, then the “Hold Inflate” target pressure is 90 mm Hg. Once the target pressure is achieved, the treatment move to next event (that is, Event 6).

At Event 6, the compressor is in the OFF state. Valve 1 is energized, closing path to atmosphere so that air bladder does not lose pressure. The wrap system starts an internal time count (that is, Time 3). Once the time count is achieved, the treatment moves to the next event (e.g., event 7).

At Event 7, the compressor is in the ON state. Valves 1 and 2 are energized, opening airway from compressor to Zone 1 and Zone 2 and closing path to atmosphere in order to pressurize Zone 1 and Zone 2. Part of the air in Zone 1 may quickly enter Zone 2, resulting in a reduction of pressure in Zone 1, while giving Zone 2 of the air bladders a “head start” to inflate beyond what the compressor alone would achieve. The pressure in Zone 1 may be greater than Zone 2, resulting in a gradient pressure from distal to proximal until the pressures in both zones equalize. Once both bladders (i.e., Zone 1 and Zone 2) have achieved equal pressure, they may remain equal during the rest of the inflation until an target pressure is achieved and remain equal for the duration of the rest of the Event 7 (Pulse Inflate). The pressure sensor is in the ON state to monitor the pressure in Zones 1 and 2 to achieve the “Pulse Inflate” target pressure. Once the target pressure is achieved, the treatment moves to the next event (e.g., event 8).

At Event 8, the compressor is in the OFF state. Valves 1 and 2 are energized, closing path to atmosphere so that air bladder does not lose pressure. The wrap system starts an internal time count (that is, Time 1). Once the time count is achieved, the treatment moves to the next event (e.g., event 9).

At Event 9, the compressor is in the OFF state. Valves 1 and 2 are de-energized, opening path to atmosphere, de-pressurizing Zones 1 and 2. The wrap system starts an internal time count (that is, Time 2). Once the time count is achieved, the treatment moves to the next event (e.g., event 10).

The above Event numbers 7-9 may create the “pulsing” sensation of compression in the skin that contacts Zone 1 and Zone 2.

At Event 10, the Event numbers 7-9 repeats as a loop for a plurality of times (e.g. two, three, or more times) based on a setting from the user. Once the Event numbers 7-9 have occurred the number of repetitions the user sets (e.g., three times), the treatment moves to the next event (e.g., event 11).

At Event 11, the compressor is in the ON state. Valves 1 and 2 are energized, opening airway from compressor to Zone 1 and Zone 2 of the air bladders and closing path to atmosphere in order to pressurize Zone 1 and Zone 2. The pressure sensor is in the ON state to monitor the pressure in Zone 1 and Zone 2 to achieve “the “Hold Inflate” target pressure” that equals to the Pulse Inflate target tressure (e.g., in Event 7)+10 mm Hg. For example, if the Pulse Inflate target pressure is 80 mm Hg, then the Hold Inflate target pressure is 90 mm Hg. Once target pressure is achieved, the treatment moves to the next event (that is, Event 12).

At Event 12, the compressor is in the OFF state. Valves 1 and 2 are energized, closing path to atmosphere so that air bladders do not lose pressure. The wrap system starts an internal time count (that is, Time 3). Once the time count is achieved, the treatment moves to the next event (e.g., event 13).

At Event 13, the compressor is in the ON state. Valves 1, 2 and 3 are energized, opening airway from compressor to zones 1, 2, and 3 of air bladders and closing path to atmosphere in order to pressurize zones 1, 2, and 3. Part of the air in Zones 1 and 2 may quickly enter Zone 3, resulting in a reduction of pressure in Zones 1 and 2, while giving Zone 3 of the air bladders a “head start” to inflate beyond what the compressor alone would achieve. The pressure in Zones 1 and/or 2 may be greater than Zone 3, resulting in a gradient pressure from distal to proximal until the pressures in all zones 1, 2, and 3 equalize. Once all zones 1, 2, and 3 of the air bladders have achieved equal pressure, they may remain equal during the rest of the inflation until an target pressure is achieved and/or remain equal for the duration of the rest of the Event 13 (Pulse Inflate). The pressure sensor is in the ON state to monitor the pressure in Zones 1, 2, and 3 to achieve the “Pulse Inflate” target pressure. Once target pressure is achieved, the treatment moves to the next event (e.g., event 14).

At Event 14, the compressor is in the OFF state. Valves 1, 2 and 3 are energized, closing path to atmosphere so that air bladder does not lose pressure. The wrap system starts an internal time count (that is, Time 1). Once the time count is achieved, the treatment moves to the next event (e.g., event 15).

At Event 15, the compressor is in the OFF state. Valves 1, 2 and 3 are de-energized, opening path to atmosphere, de-pressurizing Zones 1, 2 and 3. The wrap system starts an internal time count (that is, Time 2). Once the time count is achieved, the treatment moves to the next event (e.g., event 16).

The above Event numbers 13-15 may create the “pulsing” sensation of compression at the skin surface that contacts each of Zones 1, 2, and 3.

At Event 16, the Event numbers 13-15 repeats as a loop for a plurality of times (e.g. two, three, or more times) based on a setting from the user. Once the Event numbers 13-15 have occurred the number of repetitions the user sets (e.g., three times), the treatment moves to the next event (e.g., event 17).

At Event 17, the compressor is in the ON state. Valves 1, 2 and 3 are energized, opening airway from compressor to Zones 1, 2 and 3 of air bladder and closing path to atmosphere in order to pressurize Zones 1, 2 and 3. The pressure sensor is in the ON state to monitor the pressure in Zones 1, 2, and 3 to achieve the “Hold Inflate” target pressure that equals to the “Pulse Inflate” target pressure (e.g., in Event 13)+10 mm Hg. For example, if the Pulse Inflate target pressure is 80 mm Hg, then the Hold Inflate target pressure is 90 mm Hg. Once target pressure is achieved, the treatment moves to the next event (that is, Event 18).

At Event 18, the compressor is in the OFF state. Valves 1, 2 and 3 are energized, closing path to atmosphere so that air bladders do not lose pressure. The wrap system starts an internal time count (that is, Time 3). Once the time count is achieved, the treatment moves to next event (e.g., event 19).

At Event 19, the compressor is in the OFF state. Valves 1, 2 and 3 are de-energized, opening path from air bladders to atmosphere in order to de-pressurize zones 1, 2 and 3. The wrap system starts an internal time count (that is, Time 4). Once the time count is achieved, a full treatment cycle is completed. The wrap system may move back to Event 1 and repeat until a session time is reached as shown by the timer on the display. In some embodiments, the session timer may be pre-set by a user. In some embodiments, the number of loops as described in Event 4, 11, and/or 17 can be customized by a user.

Referring to FIG. 10, in use, the pressure in an air bladder may be in a range from about 0 mm Hg to 100 mm Hg. The Pulse Inflate target pressure may be selected in a range from about 120 mm Hg to about 160 mm Hg.

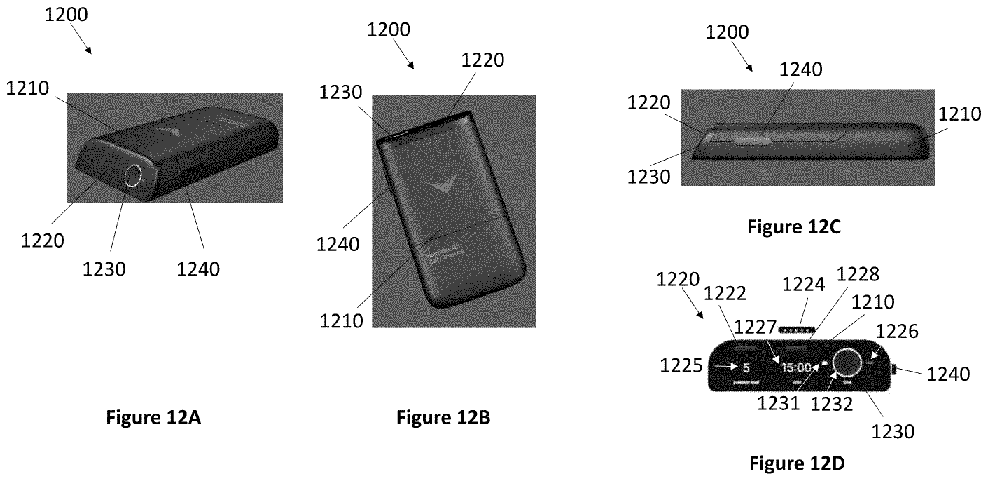

FIG. 11A is a schematic diagram illustrating communication of treatment controls and synchronization of treatment between two calf wraps, according to various embodiments. FIG. 11B is a schematic diagram illustrating communication of treatment controls between one calf wrap and a mobile device and synchronization of treatment between two calf wraps, according to various embodiments. FIG. 11C is a schematic diagram illustrating communication of treatment controls, between one calf wrap and the mobile device, and between another calf wrap and the mobile device, and synchronization of treatment between two calf wraps, according to various embodiments.

Referring to FIG. 11A, a calf wrap 1112 and a calf wrap 1114 may synchronize 1110 with each other by sending and/or receiving data in radio frequency signals using the control units 1116, 1118, respectively. As shown in FIG. 11A, in some embodiments, radio frequency (RF) can be used to drive treatment parameters (or protocols) and/or treatment synchronization between two calf wraps without using a mobile phone.

Referring to FIG. 11B, in addition to the synchronization 1110, the calf wrap 1112 may further synchronize 1120 with the mobile device 1122 by sending and/or receiving data in Bluetooth signals (or other near field communication protocols) using the control unit 1116. As shown in FIG. 11B, Bluetooth can be used to communicate treatment parameters (e.g., set by a user) between a cell phone and one calf wrap 1112. Furthermore, RF can be used to drive the treatment parameters (or protocols) and/or allow treatment synchronization between the calf wraps 1112 and 1114.

Referring to FIG. 11C, in addition to the synchronization 1110 and 1120, the calf wrap 1114 may further synchronize 1130 with the mobile device 1122 by sending and/or receiving data in Bluetooth signals using the control unit 1118. As shown in FIG. 11C, Bluetooth can be used to communicate treatment parameters (e.g., set by a user) between a cell phone and both calf wraps 1112 and 1114. Furthermore, RF can be applied to drive treatment of synchronization between these two calf wraps 1112 and 1114.

In some embodiments, the mobile device 1122 may include a mobile application (e.g., Hyperice App) to synchronize the parameters and/or protocols between the mobile device 1122 and the calf wrap(s) 1112, 1114.

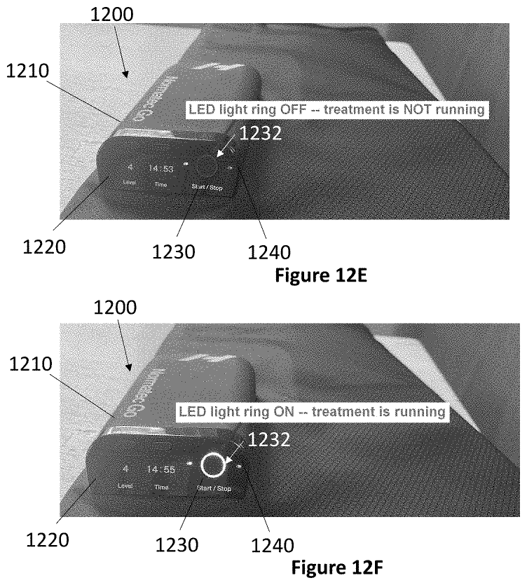

FIGS. 12A-12C illustrate perspective views of a control unit 1200, according to aspects of the present embodiments. FIG. 12D-F illustrates a display 1220 of the control unit 1200, according to aspects of the present embodiments.

Referring to FIGS. 12A-12F, the control unit 1200 may include a box 1210 to house a plurality of electro-mechanical components, as discussed above with reference to FIGS. 2 and 3. The control unit 1200 may further include a display 1220 (e.g., a white or black OLED display).

Referring to FIG. 12D, the display 1220 may include a connection (e.g., Bluetooth) status indicator 1226, a battery status indicator 1224, session time indicator (or session timer) 1227, and/or pressure level indicator 1225, which may show information of the wrap system such as the power state (e.g., ON or OFF), treatment state (e.g., Ready, Running, or Paused), timer, battery status, Bluetooth connection status, error message, and/or other suitable information of the wrap system. The Bluetooth connection status indicator 1226 may include Blue LED light(s), which may light up when the wrap system is connected (or paired) to a mobile device via e.g., BLE. The display 1220 may further include an annulus LED light (or an anulus LED light ring) 1232 circumscribing the Start/Stop button 1230. The LED light ring 1232 can be configured to (e.g., display an white light ring effect) to indicate a treatment is running or to indicate the wrap system and/or a treatment is not running. In some instances, the LED light ring 1232 can indicate a syncing status between different leg wraps. In various embodiments, the display 1220 may further include an RF connection status indicator 1231. The RF connection status indicator may include at least one additional LED light to light up when there is an RF connection between the system and a mobile device.

Referring still to FIG. 12D, the control unit 1200 may further include one or more minimal user interfaces, including a pressure level button 1222, a session time button 1228, a Start/Stop button 1230, a power button (or ON/OFF button) 1240, disposed in or in proximity to the display 1220 for a user to set personalized parameters (e.g., pressure level, session time, Start/Stop, or other suitable parameters) for a treatment and/or control the wrap system when the wrap system is in use. The power button 1240 may be embedded on one side of the box 1210, while other user interfaces (e.g., a pressure level selection button 1222, a session time selection button 1228, a Start/Stop button 1230) may be embedded in the display 1220.

Referring to FIG. 12E, in some embodiments, the annulus LED light (or an anulus LED light ring) circumscribing the Start/Stop button 1230 is adapted to be off, which indicates that the wrap system or a treatment is not running.

Referring to FIG. 12F, in some embodiments, the annulus LED light (or an anulus LED light ring) circumscribing the Start/Stop button 1230 is on and adapted to display a white light ring effect, which indicates that a treatment is running.

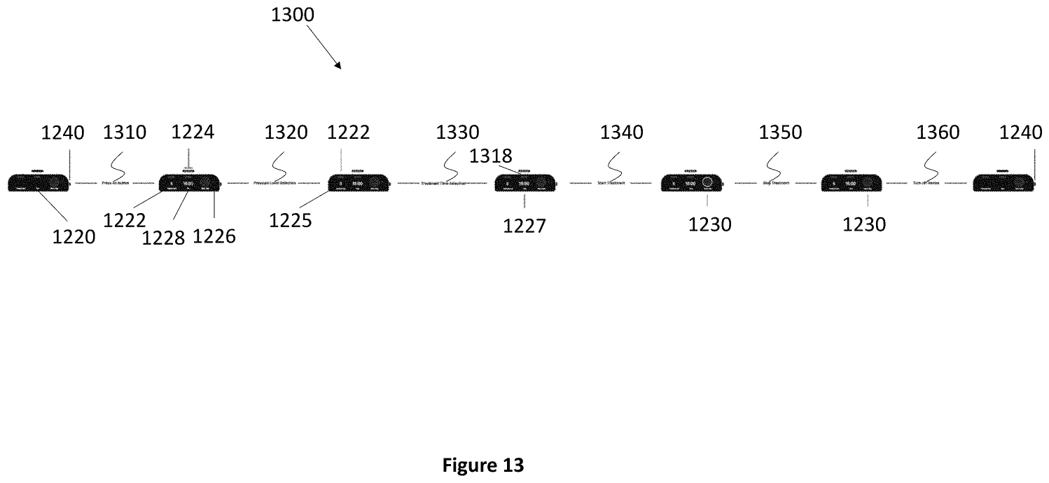

FIG. 13 illustrates a workflow 1300 for setting up personalized user controls in a wrap system, according to aspects of the present embodiments. The below description of steps is merely one example and the skilled person will understand that adjustments can be made in other embodiments.

Prior to step 1310, the wrap system may be initially in the OFF state. All lights and the display 1220 may be off.

At step 1310, a user may turn on the wrap system using the power button 1240, resulting in the display 1220 to light up and/or to show that the system is ready to use. In some embodiments (e.g., for the first time use of the wrap system), the display 1220 may show default values of e.g., pressure level 1222, battery status 1224, and/or timer 1228. In some embodiments (e.g., for previously used wrap system), the display 1220 may show previously selected values (or consistent values) of e.g., a pressure level, a battery status, and/or a session time.

At step 1320, a user may select or adjust the pressure level using the pressure level selection button 1222. In some embodiments, the pressure level selection button 1222 is a cyclical button that can select a pressure level among values of 1, 2, 3, 4, 5, or other values. The selected pressure level may be shown on the pressure level indicator 1225. In some embodiments, the selected pressure level persists across one or more power cycles. In some embodiments, the pressure level can be selected or adjusted in Ready, Running, and/or Pause states.

At step 1330, a user may select or adjust the treatment time using the session time selection button 1228. In some embodiments, the session time selection button 1228 is a cyclical button that can select a session time among values of 15:00, 30:00, 45:00, 60:00 minutes, or other values. The selected session time may be shown on the session time indicator (or session timer) 1227. In some embodiments, the selected session time persists across one or more power cycles. In some embodiments, the session time can be selected or adjusted in Ready, Running, and/or Pause states. For example, if the session time is adjusted during Running or Paused state, wherein a period of time has passed, the session time shown on the session time indicator (or session timer) 1227 may be a closest value based on the adjusted session time.

At step 1340, a user may start a treatment by using the Start/Stop button 1230. A time may be counted down (e.g., by one second increment) and shown on the session time indicator (or session timer) 1227, leading to a Running state.

At step 1350, a user may pause the treatment by using the Start/Stop button 1230. The time on the session time indicator (or session timer) 1227 may freezes, leading to a Paused state.

At step 1360, a user may turn off the system (e.g., after the treatment is completed) by using the power button (or ON/OFF button) 1240. All lights and the display are off, leading to an OFF state.

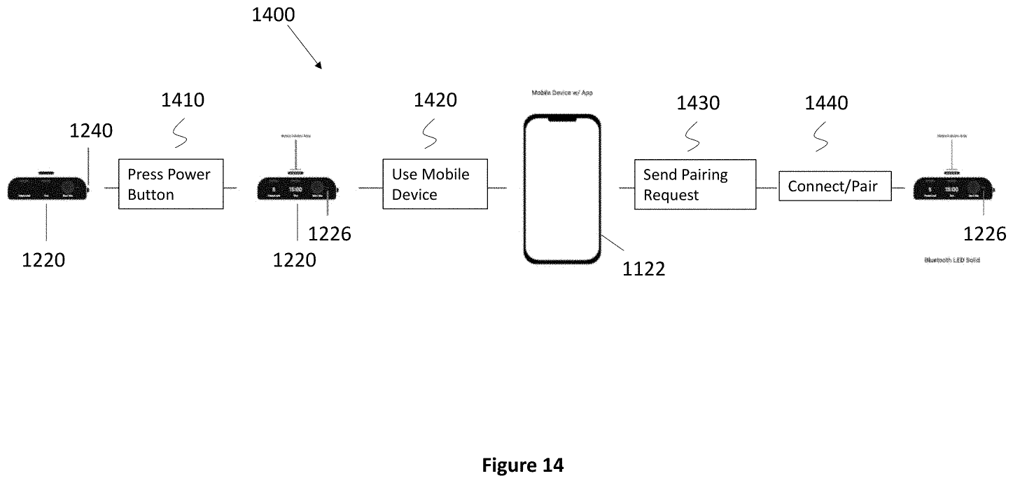

FIG. 14 illustrates a workflow 1400 for setting up Bluetooth pairing (or connection) between a wrap system and a mobile device using user controls, according to aspects of the present embodiments. The below description of steps is merely one example and the skilled person will understand that adjustments can be made in other embodiments.

Prior to step 1410, the wrap system may be initially in the Off state, represented by that all lights and the display 1220 are off.

At step 1410, a user may press the power button 1240 to turn on the wrap system, resulting in the display 1220 to light up and/or to show that the system is ready to use. In some embodiments (e.g., for the first time use of the wrap system), the display 1220 may show default values of pressure level, battery status, timer, and/or other parameters of user controls. In some embodiments (e.g., for previously used wrap system), the display 1220 may show previously selected values (or consistent values) of pressure level, battery status, timer, and/or other parameters of user controls.

At step 1420, a user may prepare a mobile device 1122 for pairing or connection. The pairing may ensure Bluetooth signals are enabled between the wrap system and the mobile device 1122. The mobile device 1122 may include a mobile application for the user to set up parameters and/or protocols of the treatment remotely.

At step 1430, a user sends a pairing request from the mobile device 1122 to the control unit of the wrap system.

At step 1440, the control unit of the wrap system receives the pairing request, and then connect with the mobile phone 1122. If the connection (or pairing) is successful, the Bluetooth LED 1226 on the display 1220 turns on to show solid light.

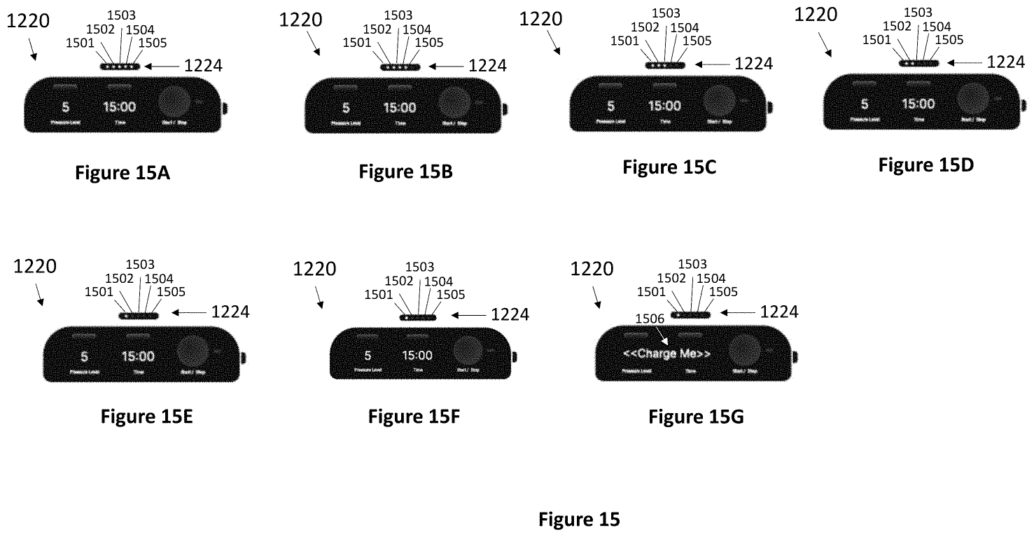

FIG. 15A-15G illustrate example views of a battery status indicator 1224 showing battery statuses, according to aspects of present embodiments.

The battery status indicator 1224 includes one or a plurality of (e.g., 5) white LED indicators. The one or a plurality of (e.g., five) LED indicators 1501, 1502, 1503, 1504, and/or 1505 may be used to show the following information without having to light up other parts of the display: 1) the battery status when the wrap system is in use and/or 2) the charging status when the wrap system is charging. In some embodiments, the LED indicators 1501, 1502, 1503, 1504, and/or 1505 may include white LED lights. In some embodiments, the battery status indicator 1224 may include battery blinking animation to indicate that the battery is in the charging state.

In the some embodiments, a percentage of the battery status indicated by the LED indicators 1501, 1502, 1503, 1504, and/or 1505 may be a reference value based on actual battery voltages as measured by the PCB, and it is not the actual voltage or charge of the battery, as described herein.

Referring to FIG. 15A, all the LED indicators 1501, 1502, 1503, 1504, and 1505 in the battery status indicator 1224 are on, indicating battery charge status in a range from higher than about 80% to about 100% (e.g., about 81%, 85%, 90%, 95%, or 100%).

Referring to FIG. 15B, the LED indicators 1501, 1502, 1503, 1504 are on, while the LED indicator 1505 is off, indicating battery charge status in a range from higher than 60% to 80% (e.g., 61%, 65%, 70%, 75%, or 80%).

Referring to FIG. 15C, the LED indicators 1501, 1502, 1503 are on, while the LED indicator 1504, 1505 are off, indicating battery charge status in a range from higher than 40% to 60% (e.g., 41%, 45%, 50%, 55%, or 60%).

Referring to FIG. 15D, the LED indicators 1501, 1502 are on, while the LED indicator 1503, 1504, 1505 are off, indicating battery charge status in a range from higher than 20% to 40% (e.g., 21%, 25%, 30%, 35%, or 40%). .

Referring to FIG. 15E, the LED indicator 1501 is on, while the LED indicators 1503, 1504, 1505 are off, indicating battery charge status in a range from zero to 20% (e.g., 0 or 20%).

Referring to FIG. 15F, in some embodiments, the LED indicator 1501 blinks, while the LED indicators 1503, 1504, 1505 are off, indicating battery charge status is 0% and warning user that system is about to enter a low battery state and is about to stop treatment. In some embodiments, the battery may be configured (e.g., by an on-board protection circuit of the battery, or other firmware) to not enter a deep or full discharge state (e.g., an actual 0 volt) when the system is running. when the battery charge status is 0% indicated by the LED indicators. Therefore, “0%” indicated by the LED indicators may not refer to an actual 0 volt, but a voltage value (e.g., driven by firmware), such as the voltage that the battery needs to be able to run the components like the pump and valves without any errors. In some embodiments, the battery charge status is 0% if the battery voltage is below a threshold above an actual 0 volt. Accordingly, the wrap system may be able to run treatment when the battery charge status is about 0%.

Referring to FIG. 15G, when the battery charge status is below 0% (e.g., if the battery voltage is below a threshold), a low battery message (or error message) 1506 may show up on the display 1220 and/or there may be no lights, which indicate that the treatment is not running. In some embodiments, the low battery message 1506 is “Low Battery Please Charge,” and may scroll vertically across the display 1220. The user may be locked out of all controls except the power button (i.e., the ON/OFF button). Accordingly, the user may need to connect the wrap system to a DC power supply to charge the battery.

In some embodiments, the low battery message occurs when the wrap system is in the Ready state. In such case, after the wrap system is charged, the system may be in the Ready state. The Ready state may be shown on the display 1220.

In some embodiments, the low battery message occurs when the system is in a Running state (i.e., when the system is running e.g., an treatment algorithm) or the Paused state (i.e., the system is paused). In such cases, after the wrap system is charged, the system may be in the Paused state, and both the Paused state and the quantitative value of the timer when low battery message appears and/or when the treatment stops may be shown on the display 1220.

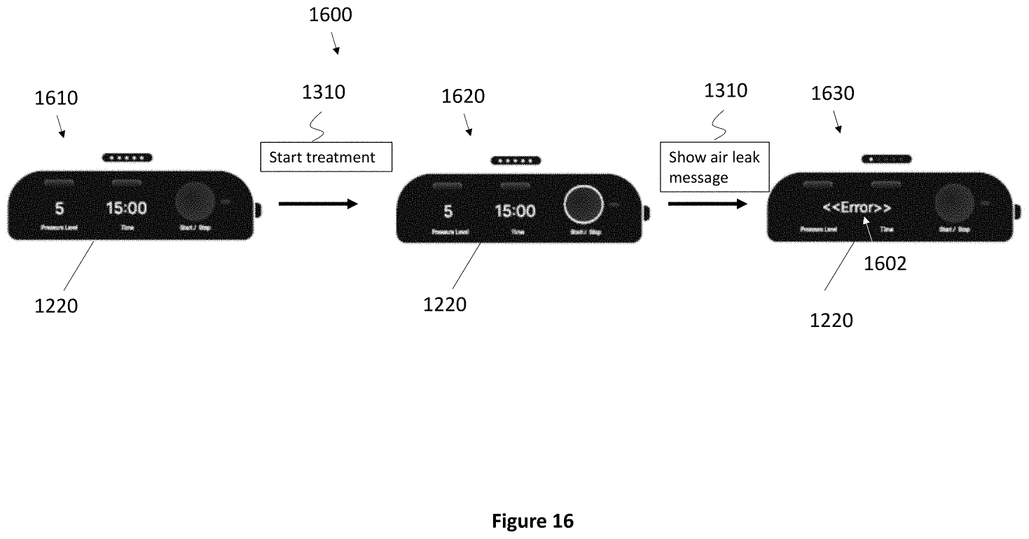

FIG. 16 illustrates a block diagram 1600 of the wrap system showing air leak error message on the display 1220, according to various embodiments. This is based on a piece of firmware logic that starts when treatment enters the Running State and ends anytime the treatment enters any other state, as described herein.

At Module 1610, the wrap system is in the Ready state.

At Module 1620, the wrap system starts the treatment and is therefore in the Running state.

At Module 1630, if the wrap system detects the air leak in the air bladder(s), the display 1220 may show an air leak error message 1602. An example detection of the air leak is described herein. During the running of the compressor, the system checks whether a target pressure has been reached in the air bladder(s) within a pre-determined time (e.g., 2 minutes) by using a timer (e.g., a timer in the code or algorithm of the system that is running) that starts at the time the compressor turns on. If the timer reaches two minutes and the air bladder(s) do not reach the target pressure, the system may stop the treatment and show the “Air Leak” message on the display 1220.

The systems in the present disclosed embodiments may be a Class II Medical Device. In some instances, the system may include a non-medical grade charger which would mean that the device could not be run when charging.

### Computer-Based Implementations

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as an algorithm, a treatment algorithm, a treatment algorithm event, an event, a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “about” and other similar phrases, as used in the specification and the claims (e.g., “X includes a value of about Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in this specification the term “air bladder” refers to any compartment capable of being independently inflated and/or deflated. In some embodiments, the term “at least two air bladders” can describe two or more distinct casings/bladders. But in other embodiments, the term “at least two bladders” can refer to a single outer casing/bladder that includes two or more distinct compartments (or chambers). Other structures are possible and contemplated.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

As various changes could be made in the above constructions without departing from the scope of the invention, it is intended that all the matter contained in the above description or shown in the accompanying drawings shall be interpreted as illustrative and not in a limiting sense.

### EXAMPLES

### Example 1—Example Calf Wraps

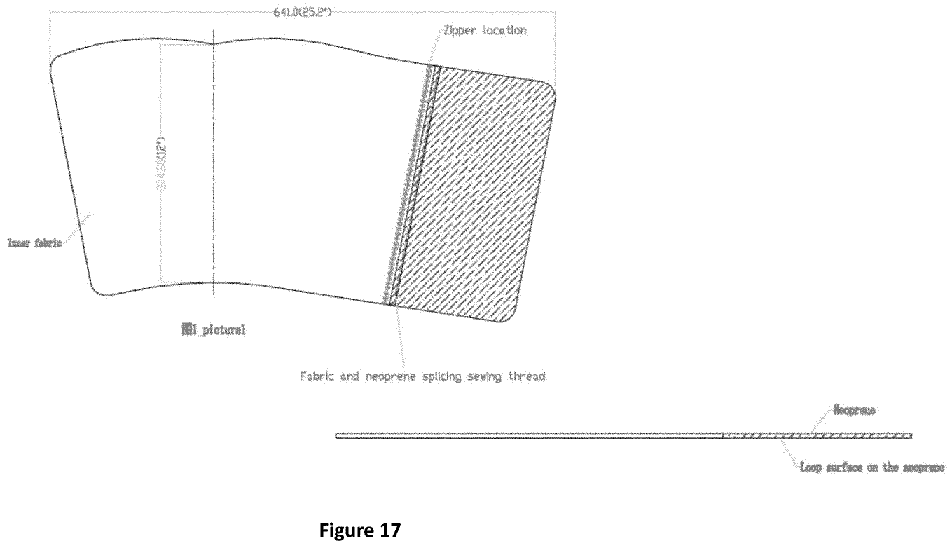

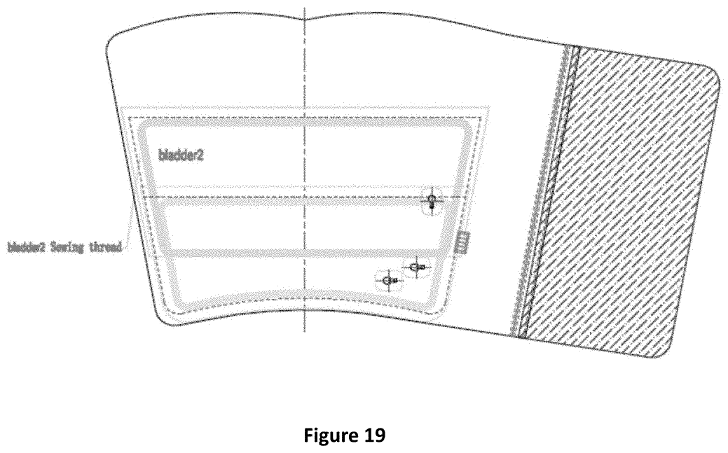

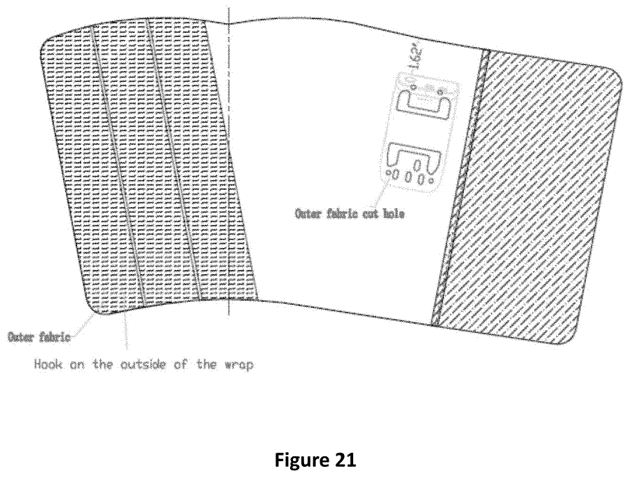

FIGS. 17-23 illustrate example constructions of a calf wrap. FIGS. 17-20 illustrate construction of the inner layer of the calf wrap. FIGS. 21-23 illustrate construction of the outer layer of the calf wrap. The constructions of the calf wrap included certain portions, elements, and/or features (e.g., sizes), as described herein.

As shown in FIG. 17, the height of the calf wrap can be from about 13 inches to about 11 (or about 12 inches), resulting in an improved compactness. Additionally, the width of the calf wrap can be from about 21 inches to about 26 inches (e.g., about 25 inches). The calf wrap included a zipper line and/or a sewing thread, which extended from e.g., a top edge to a bottom edge of the calf wrap and were disposed near the interface between a neoprene portion and an additional fabric (e.g., nylon) portion. As also shown in a cross section view of the calf wrap in FIG. 17, a loop surface was located on the neoprene portion.

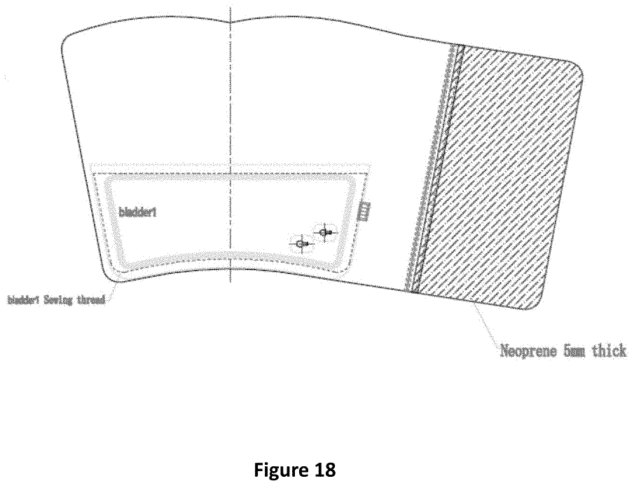

As shown in FIG. 18, the neoprene portion included a thickness of about 5 mm.

As shown in FIGS. 18-20, one or more sewing threads were included for constructing the calf wrap (e.g., sewing the bladder to the inner layer and/or the outer layer of the calf wrap).

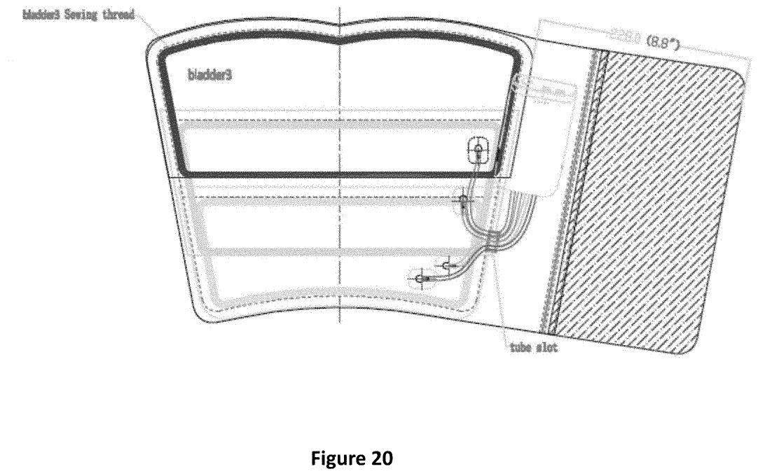

As shown in FIG. 20, a hook part (or a part of the calf wrap that does not include the bladders) had a width of about 8 to about 10 inches (e.g., 8.8 inches). Further, a tube slot may be included in the construction to organize the wires that would be used to operatively connect the control unit to other electrical elements of the calf wrap.

As shown in FIGS. 21-23, the hook portion of the outer layer was constructed so that the loop was facing inward. The bladder portion of the outer layer included an outer fabric to hook on the hook portion of the wrap. The outside layer further included one or more outer fabric cut holes for operatively holding a control unit. In some scenarios, the location of the control unit on the calf wrap includes a distance of about 1 inch from the neoprene portion, and about 1-2 inches (e.g., 1.6 inches) from the top edge of the calf wrap.

### Example 2—Example Calf Wraps and/or Control Units in Use

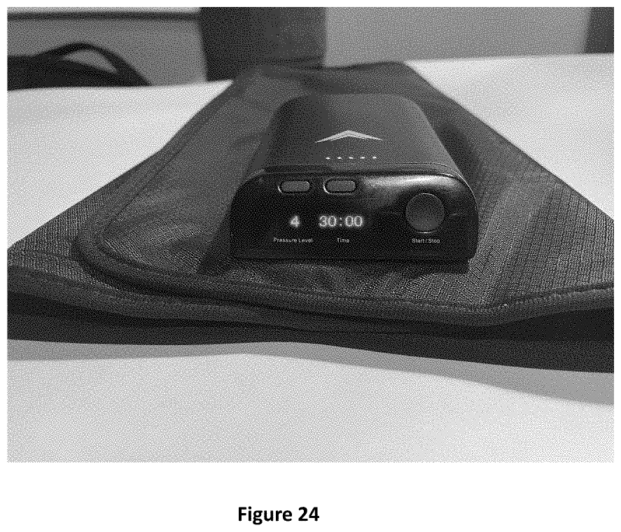

FIGS. 24-32 illustrate example calf wraps and/or control units in use, as described herein. The control unit is attached to the outer layer of a calf wrap. The control unit includes a display to show information such as a battery charge status, a pressure level, a time session, and/or other features.

As shown in FIG. 24, the pressure level was selected as “4” and the session time was selected as “30:00.”

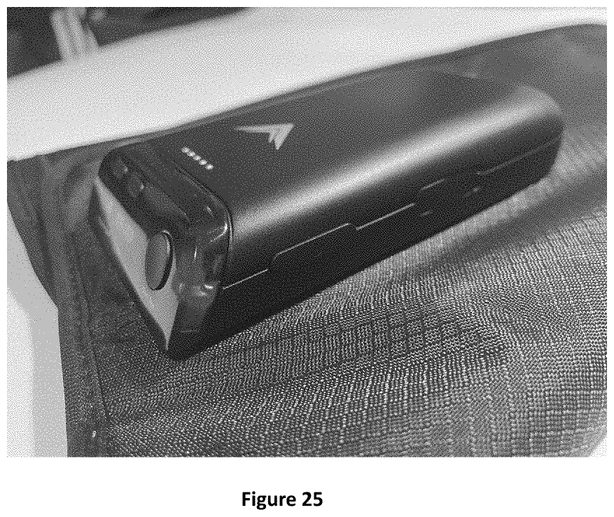

As shown in FIG. 25, the power button was turned on, represented by a blue light. Additionally, five LED indicators were on, indicating the battery charge status was higher than 80%.

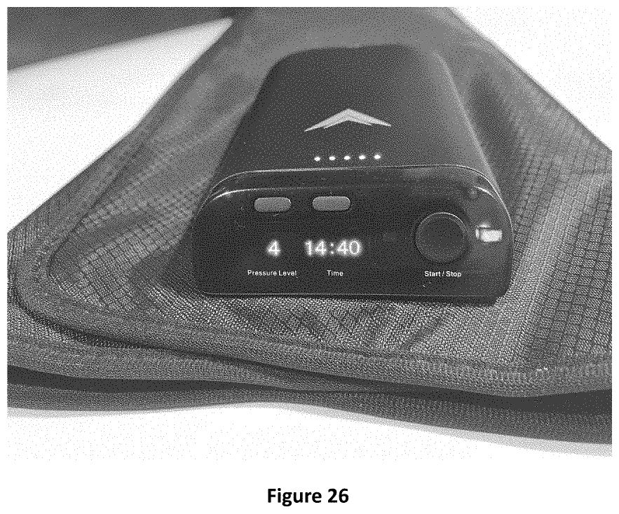

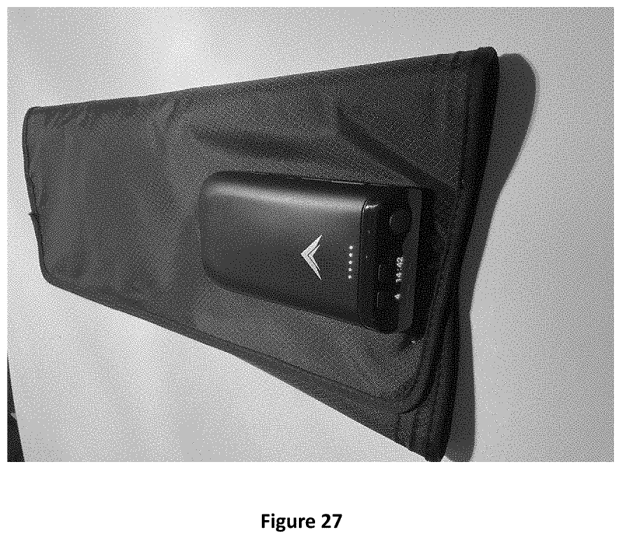

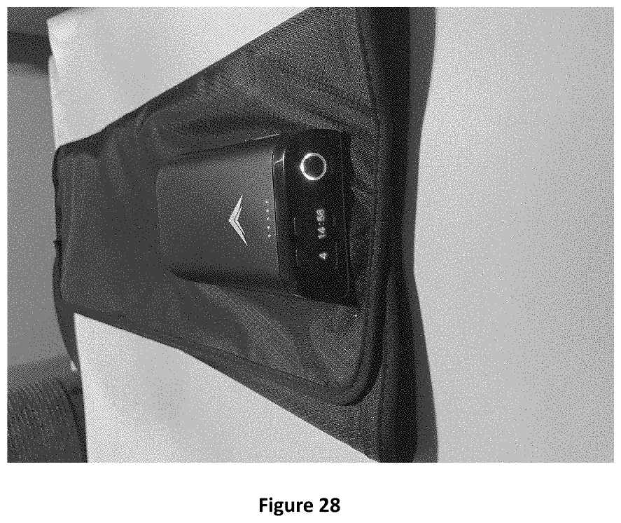

As shown in FIGS. 26-28, the calf wrap was in Paused state, where the pressure level was “4” and the session time was 14:40 (FIG. 26), 14:42 (FIG. 27), or 14:56 (FIG. 28).

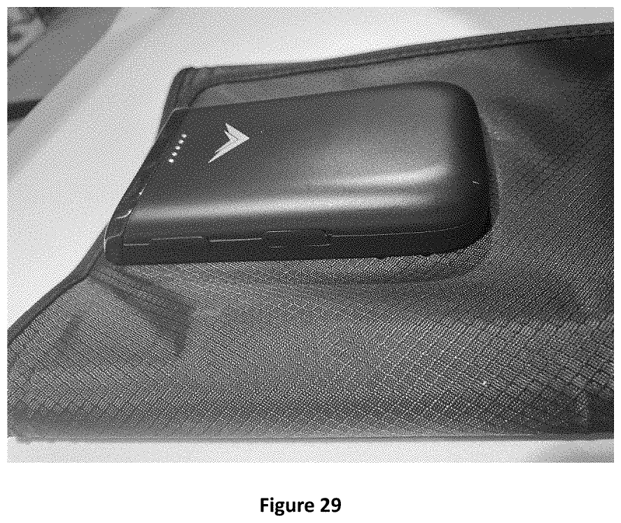

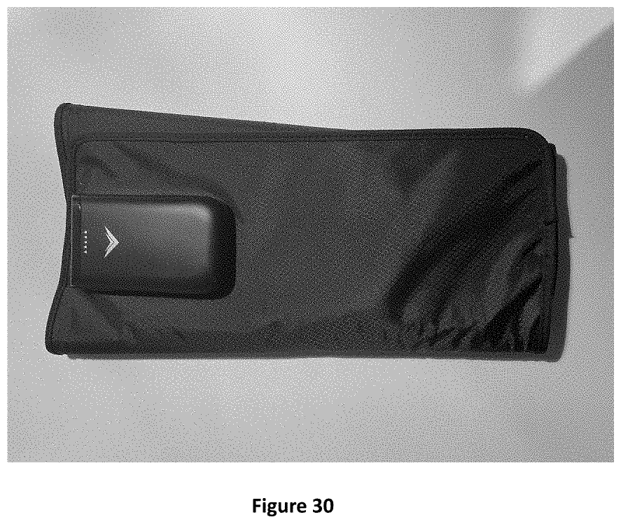

As shown in FIGS. 29 and 30, five LED indicators were on, indicating the battery charge status was higher than 80%.

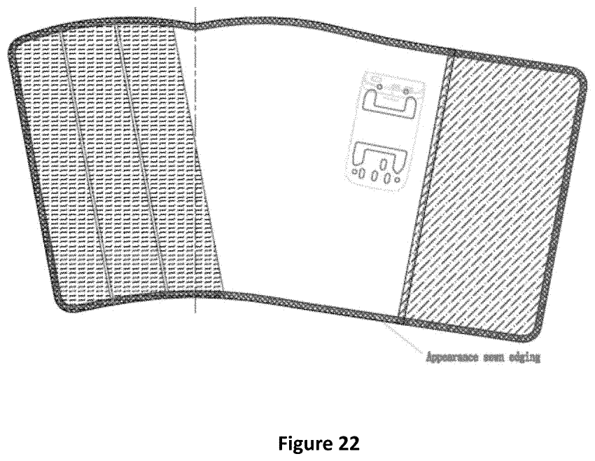

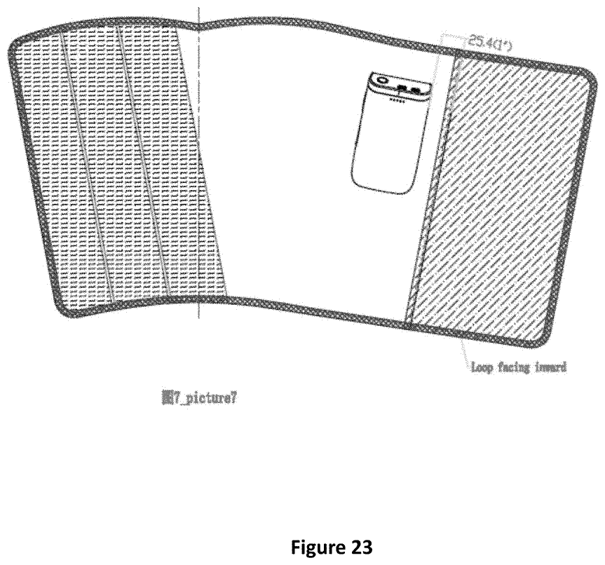

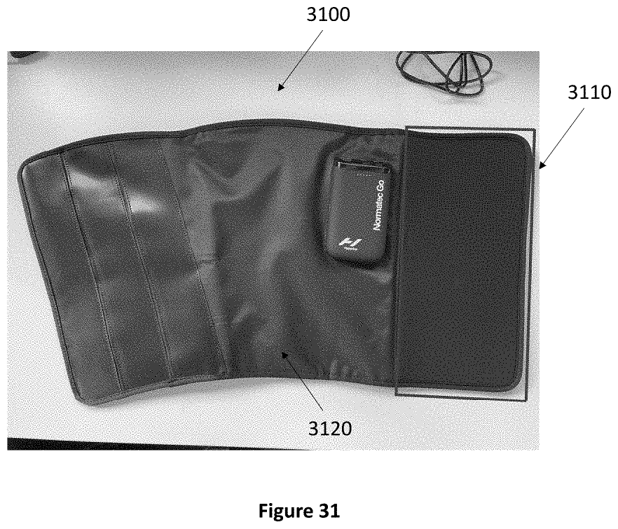

As shown in FIG. 31, the control unit is attached on the outside face of the calf wrap (e.g., corresponding to constructions of the calf wrap in FIGS. 22 and 23).

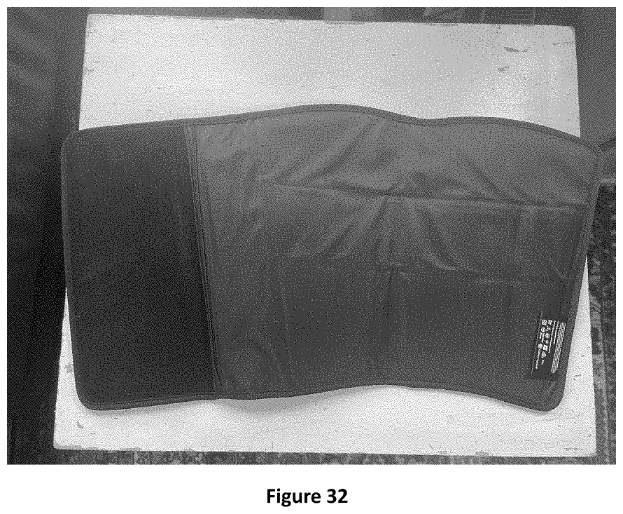

As shown in FIG. 32, the calf wrap includes an inner layer. In use, the inner layer would be close to or in contact with a skin surface of a user. The air bladders were sewn between the outer layer and the inner layer of the calf wrap.

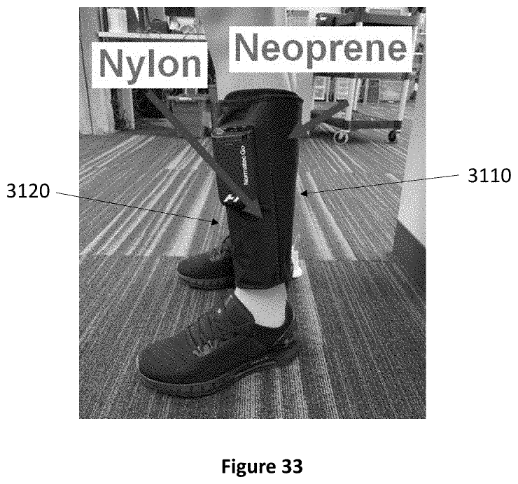

As shown in FIG. 33, a calf wrap was wrapped around the limb of a user for use.

Referring to FIGS. 31-33, in some scenarios, the inner layer and/or the outer layer of the calf wrap includes neoprene fabric in combination with nylon material to house the bladders. For example, a portion (e.g., a portion 3110 in FIG. 31) of the calf wrap 3100 was made of neoprene fabric and other portions (e.g., a portion 3120 of the inner layer in FIG. 31) of the calf wrap 3100 includes nylon. Advantageously, The use of neoprene allowed the user to affix the calf wrap 3100 tightly around the limb as it stretches and forms according to the user's physiology.

U.S. Pat. No. 5,968,073, is incorporated by reference herein in its entirety.

What is claimed is:

1. A system for applying pneumatic compression to a portion of a body comprising:
a wrap comprising at least two air bladders; and
a control unit,
wherein the control unit is configured to control the air pressure in the at least two air bladders.

2. The system of claim 1, wherein the wrap comprises at least one of a calf wrap, a foot wrap, an ankle wrap, a shoulder wrap, an arm wrap, a thigh wrap, a knee wrap, a forearm wrap, an elbow wrap, a bicep wrap, an upper arm wrap, and a shoulder wrap.

3. The system of claim 1, wherein the wrap further comprises:
an outer layer comprising means to (i) fasten the wrap to a user and (ii) force pressure from the at least two air bladders toward the user; and
an inner layer close to or in contact with a skin surface of the user,
wherein the at least two air bladders are disposed between the outer layer and the inner layer.

4. The system of claim 1, wherein the at least two air bladders comprise overlapping areas between adjacent air bladders.

5. The system of claim 1, wherein the control unit comprises at least one of a compressor, a plurality of solenoid valves, a battery, a printed circuit board (PCB), a battery charging interface, a user interface, and a programming interface, and wherein the battery charging interface is a USB-C charging port.

6. The system of claim 5, wherein the plurality of solenoid valves are configured to at least one of inflate or deflate the at least two air bladders.

7. The system of claim 5, wherein the control unit further comprises a Bluetooth chip to achieve Bluetooth connection between the system and a mobile device.

8. The system of claim 5, wherein the compressor is a miniature DC compressor.

9. The system of claim 5, wherein the user interface comprises at least one of a display, a pressure level button, a session time button, a start/stop button, a Bluetooth connection status indicator, an RF connection status indicator, and a battery status indicator.

10. The system of claim 9, wherein the display comprises an organic light-emitting diode (OLED) display.

11. The system of claim 9, wherein the Bluetooth connection status indicator comprises a blue LED to light up when connected to a mobile device.

12. The system of claim 1, wherein the system runs a treatment algorithm to generate pulsing sensation from at least part of the at least two air bladders to skin.

13. The system of claim 1, further comprising:
one or more additional wraps comprising at least two air bladders; and
one or more additional control units,
wherein the control unit and the one or more additional control units are configured to allow synchronous control between the wrap and the one or more additional wraps using RF communication.

14. A system for applying pressure to a portion of a body, comprising:
a first body wrap comprising a first plurality of air bladders;
a first control unit disposed on the first body wrap;
a second body wrap comprising a second plurality of air bladders; and
a second control unit disposed in the second body wrap,
wherein the first control unit and the second control unit include electro-mechanically autonomous systems configured to achieve synchronization between the first plurality of air bladders and the second plurality of air bladders.

15. The system of claim 14, wherein the synchronization is achieved by RF communication between the first plurality of air bladders and the second plurality of air bladders.
